(19) United States
(12) Patent Application Publication
(10) Pub. No.: US 2017/0017761 A1
(43) Pub. Date: Jan. 19, 2017

(54) MEDICAL CARE SUPPORT DEVICE AND METHOD, AND MEDICAL CARE INFORMATION STORAGE DEVICE AND METHOD

(71) Applicant: FUJIFILM Corporation, Tokyo (JP)

(72) Inventor: Akinari TSUGO, Ashigarakami-gun (JP)

(73) Assignee: FUJIFILM Corporation, Tokyo (JP)

(21) Appl. No.: 15/279,785

(22) Filed: Sep. 29, 2016

Related U.S. Application Data
(63) Continuation of application No. PCT/JP2015/057934, filed on Mar. 17, 2015.

(30) Foreign Application Priority Data
Mar. 31, 2014 (JP) 2014-074278

(51) Int. Cl. G06F 19/00; G06F 17/30

(52) U.S. Cl. CPC G06F 19/345; G06F 19/324; G06F 19/3406; G06F 19/3443; G06F 17/30424

(57) ABSTRACT

Provided is a medical care support device capable of allowing a causal relationship in a plurality of pieces of medical care information to be simply ascertained, and performing accumulation of information so that a causal relationship serving as a basis of clinical decision or a group of causal relationships can be simply ascertained.

A medical care support server generates, on the basis of an instruction from a client terminal, set information in which a plurality of pieces of first and second information corresponding to each of a plurality of specified positions in different pieces of time-series data are associated with each other, groups one or more pieces of set information in units of clinical decision according to a grouping instruction to create an information group, and accumulates the information group in a disease example DB. Clinical decision can be added to the information groups.

### CROSS-REFERENCE TO RELATED APPLICATION

This application is a Continuation of PCT International Application PCT/JP2015/057934 filed on 17 Mar. 2015, which claims priority under 35 USC 119(a) from Japanese Patent Application No. 2014-074278 filed on 31 Mar. 2014. The above application is hereby expressly incorporated by reference, in its entirety, into the present application.

### BACKGROUND OF THE INVENTION

1. Field of the Invention

The present invention relates to a medical care support device and method, for supporting medical care and a medical care information storage device and method.

2. Description of the Related Art

In recent years, various medical care information acquired in the medical care of a patient has been stored and managed as electronic data using a computer system. In the medical care information, for example, measured values of vital signs such as a heart rate, a pulse rate, blood pressure, and body temperature, inspection values in specimen inspection such as blood inspection, and data regarding treatment such as a name of an administered drug and a dosage are included. A medical care support device that performs storage or display of such medical care information to support medical care is known. In medical care, it is important to recognize a transition of a condition of a patient such as a changeover time in body temperature or blood pressure or a change in inspection values of a plurality of inspections performed in different periods of time, or recognize content of treatment or therapy in time series. Therefore, a medical care support device that displays, in a graph form, time-series data in which measured values or inspection values of a vital sign is recorded in time series is known (see, for example, JP2012-063997A and JP2013-084082A).

In the medical support device of JP2012-063997A, a plurality of items of time-series data can be displayed in each medical care action such as medication, inspection, or injection. Further, paragraph 0031 in JP2012-063997A describes that a plurality of items of time-series data are associated with each other.

A medical care support device in JP2013-084082A can also display time-series data of inspection values in the form of a graph, and can display a plurality of items of time-series data, as in JP2012-063997A. For each item of the time-series data, an indicator can be assigned at any designated position in the time-series data. Further, a comment regarding medical examination, therapy, or the like, which is related to an inspection value to which the indicator has been assigned, can be recorded in association with the indicator.

In the event that content of a treatment or a therapy for a patient is determined, it is necessary to examine medical care information such as time-series data in detail in order to accurately recognize a state of a patient, and it is important to recognize the causal relationship between a plurality of pieces of medical care information. For example, in a case in which the blood pressure decreases due to medication, a result of a decrease in blood pressure occurs due to a cause of the medication. Content of next treatment or therapy can be appropriately determined by recognizing such a causal relationship.

A causal relationship may be ascertained, for example, in the following procedure using a function of displaying a plurality of items of time-series data described in JP2012-063997A or JP2013-084082A. First, a time, a period, or an interval at which medication is performed is displayed in one piece of time-series data, and a change over time in blood pressure is displayed in another time-series data. Through work of collating a plurality of pieces of such time-series data, a timing of medication as a cause or a timing at which an effect of medication such as a decrease in blood pressure has been expressed as a result is obtained, and a causal relationship between the medication and the decrease in blood pressure can be ascertained. In a case in which such a causal relationship is ascertained, a doctor further performs clinical decision, for example, to determine whether to continue medication in order to decrease blood pressure or stop the medication since the blood pressure decreases to a target value, as content of treatment or therapy to be next performed.

A causal relationship in a plurality of pieces of medical care information is a basis of a clinical decision made by a doctor. One causal relationship may be used as the basis or a plurality of causal relationships may be logically collected until the doctor makes one clinical decision. Assuming that a causal relationship serving as the basis of one clinical decision or a group of causal relationships is known, it is possible to recognize a decision process of the doctor. The causal relationship serving as a basis of clinical decision can be used for verification of whether the decision is appropriate, and also has a value as a past disease example including a decision know-how of a doctor. Therefore, a technology for simply looking back at a group of causal relationships serving as a basis of clinical decision, in addition to individual causal relationships, has been required. This is not described in JP2012-063997A and JP2013-084082A.

### SUMMARY OF THE INVENTION

An object of the present invention is to provide a medical care support device and method, and a medical care information storage device and method capable of allowing a causal relationship in a plurality of pieces of medical care information to be simply ascertained, and performing accumulation of information so that a causal relationship serving as a basis of clinical decision or a group of causal relationships can be simply ascertained.

In order to solve the above problem, a medical care support device of the present invention comprises a reception unit and an association processing unit. The reception unit receives an association instruction for first information and second information that are designated or input with respect to medical care information of a patient. The association processing unit creates one piece of set information including at least two pieces of information including the first information and the second information on the basis of the association instruction, and groups the one or more pieces of set information in units of clinical decision to create an information group.

It is preferable for the association processing unit to be capable of adding an input comment to the set information, in addition to the first and second information.

It is preferable for the set information to include causal relationship information indicating that one of the first information and the second information corresponds to a cause and the other corresponds to a result.

It is preferable for the association processing unit to be capable of adding content of the clinical decision to the information group, in addition to the set information.

It is preferable that the first information is data of a first designated position in the first time-series data, and the second information is data of a second designated position in second time-series data. The medical care information includes first time-series data and second time-series data which are data series over time regarding a state transition and medical care of the patient.

It is preferable for the medical care support device of the present invention to further comprise a search request reception unit and a similar disease example search unit. The search request reception unit receives a search request in which at least one piece of set information is designated as a search condition. The similar disease example search unit searches for a similar disease example that is similar to the set information designated as the search condition from the disease example database in which a plurality of information groups are registered as disease examples.

It is preferable for the similar disease example search unit to include an individual degree-of-similarity calculation unit and an overall degree of similarity calculation unit. The individual degree-of-similarity calculation unit compares a plurality of pieces of set information included in the search condition with a plurality of pieces of set information included in the disease example on a one-to-one basis, and calculates an individual degree of similarity between pieces of set information. The overall degree of similarity calculation unit calculates an overall degree of similarity between the information group of the plurality of pieces of set information included in the search condition and the disease example on the basis of the plurality of calculated individual degrees of similarity.

It is preferable that one of the first information and the second information included in the set information corresponds to a cause, and the other corresponds to a result, and the individual degree-of-similarity calculation unit calculates an individual degree of similarity through a comparison between the same types corresponding to the causes and the results for the first information and the second information.

It is preferable for the similar disease example search unit to perform a weighting process on the individual degree of similarity according to the type of set information.

It is preferable for the similar disease example search unit to perform re-search each time one piece of set information of the search condition is added, and output the search result in each re-search.

It is preferable for the medical care support device to further comprise a screen data generation unit that generates screen data of a display screen for displaying the medical care information, the display screen being capable of allowing an input of the association instruction for the first information and the second information and a display of the set information.

It is preferable that in a case in which the screen data of the display screen is distributed to a plurality of terminals and used in a conference in which a plurality of people examine a medical care plan for a patient, the association processing unit is capable of storing the plurality of pieces of set information accessed during the conference, in the information group having one conference as a unit.

It is preferable that there are a preparation period and a production period in the period of the conference, and the association processing unit is capable of separately storing an information group created in the production period and an information group created in the preparation period.

It is preferable for the association processing unit to determine a start and end of the conference according to an input from the operation portion. An operation portion for inputting start and end timings of the conference is provided in the display screen.

It is preferable for the association processing unit to store an access order for a plurality of pieces of set information accessed during a period of the conference, as access information.

It is preferable that a medical care support method of the present invention comprises a reception step and an association processing step. The reception step includes receiving an association instruction for first information and second information that are designated or input with respect to medical care information through a display screen for displaying the medical care information of a patient. The association processing step includes creating one piece of set information including a set of at least two pieces of information including the first information and the second information on the basis of the association instruction, and grouping one or more pieces of set information in units of clinical decision to create an information group.

A medical care support program of the present invention causes a computer to execute each step.

A medical care information storage device of the present invention comprises a storage request reception unit and a storage processing unit. The storage request reception unit receives a storage request to store one piece of set information including a set of at least first information and second information associated with respect to medical care information of a patient, and an information group including one or more pieces of set information and grouped in units of clinical decision. The storage processing unit stores the set information and the information group in a storage unit on the basis of the received storage request.

A medical care information storage method of the present invention comprises a storage request reception step and a storage processing step. The storage request reception step includes receiving a storage request to store one piece of set information including a set of at least first information and second information associated with respect to medical care information of a patient, and an information group including one or more pieces of set information and grouped in units of clinical decision. The storage processing step includes storing the set information and the information group in a storage unit on the basis of the received storage request.

A medical care information storage program of the present invention causes a computer to execute each step.

According to the present invention, the association instruction for the first information and the second information that are designated or input with respect to medical care information of a patient is received, and the one or more pieces of set information including a set of at least two pieces of information of the first information and the second information are grouped in units of clinical decision to create an information group. Through this grouping, it is possible to simply ascertain a causal relationship in a plurality of pieces of medical care information, and to perform accumulation of information so that a causal relationship serving as a basis of clinical decision or a group of causal relationships can be simply ascertained.

### BRIEF DESCRIPTION OF THE DRAWINGS

FIG. 1 is an illustrative diagram illustrating a configuration of a medical care information system in which the present invention is embodied.

FIG. 2 is an illustrative diagram illustrating an example of time-series data recorded in an electronic medical chart.

FIG. 3 is an illustrative diagram illustrating an example of time-series data recorded in an image server.

FIG. 4 is an illustrative diagram illustrating a flow of main information on the medical care information system.

FIG. 5 is a block diagram illustrating an electrical configuration of a computer used for a medical care support server or the like.

FIG. 6 is an illustrative diagram illustrating a functional overview of a client terminal.

FIG. 7 is an illustrative diagram illustrating an example of a data display screen.

FIG. 8 is an illustrative diagram illustrating an operation of assigning an association indicator.

FIG. 9 is an illustrative diagram illustrating an association setting screen in a state in which a cause position and a result position to be associated with each other have been designated.

FIG. 10 is an illustrative diagram illustrating generation of group information.

FIG. 11 is an illustrative diagram illustrating a schematic function of a medical care support server.

FIG. 12 is an illustrative diagram illustrating a schematic function of an association processing unit.

FIG. 13 is a flowchart illustrating a schematic association and grouping procedure.

FIG. 14 is an illustrative diagram illustrating an example in which information input as text data is set information.

FIG. 15 is an illustrative diagram illustrating a conference in a second embodiment.

FIG. 16 is an illustrative diagram illustrating a screen for selecting set information to be grouped.

FIG. 17 is an illustrative diagram illustrating an information group grouped in a preparation period and a conference.

FIG. 18 is an illustrative diagram illustrating a schematic function of a search unit regarding search for a similar disease example.

FIG. 19 is an illustrative diagram schematically illustrating a procedure of calculating a degree of similarity.

FIG. 20 is an illustrative diagram illustrating a change in a search result with respect to a change in a search condition.

FIG. 21 is an illustrative diagram illustrating an example in which a data distribution server that distributes a data display screen is provided separately from the medical support server.

FIG. 22 is an illustrative diagram illustrating an example in which a client terminal is a medical care support device.

FIG. 23 is an illustrative diagram illustrating a function of a disease example DB server.

FIG. 24 is an illustrative diagram illustrating a configuration of a medical care information system in which a medical care support server is arranged outside a medical facility.

FIG. 25 is an illustrative diagram illustrating a configuration of a medical care information system in which a medical care support server, an electronic medical chart server, and an image server are arranged outside a medical facility.

FIG. 26 is an illustrative diagram illustrating a configuration of a medical care information system in which a medical care support server is arranged in a medical facility, and an electronic medical chart server and an image server are arranged outside the medical facility.

### DESCRIPTION OF THE PREFERRED EMBODIMENTS

### First Embodiment

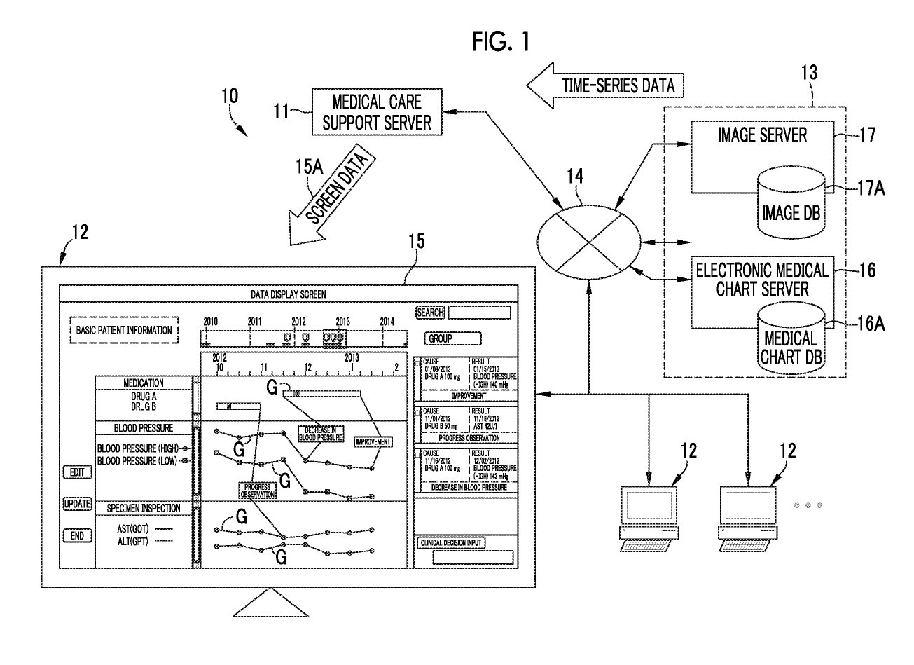

A medical care information system 10 illustrated in FIG. 1 is a computer system that is used to manage information on medical care at a medical facility such as a hospital. This medical care information system 10 includes a medical care support server 11, a client terminal 12, a server group 13, and a network 14 that connects the components so that the components can communicate with each other. In the server group 13, for example, an electronic medical chart server 16, and an image server 17 are included. The network 14 is, for example, a local area network (LAN) that is laid in a hospital.

The client terminal 12 is a terminal that is installed in respective medical care departments such as an internal medicine, a surgery, an otolaryngology, and ophthalmology and is operated, for example, by a doctor in the medical care department. The client terminal 12 has a function of accessing the electronic medical chart server 16 and inputting and viewing electronic medical charts. Medical care information including a record of medical examination such as medical interview, inspection, or diagnosis, and a record of treatment such as treatment or surgery are input to the electronic medical chart. Further, the client terminal 12 has a function of accessing the image server 17 and viewing inspection images such as X-ray images.

Further, the client terminal 12 has a function of accessing the medical care support server 11 and viewing a data display screen 15 on which medical care information of a patient is displayed. In the data display screen 15, time-series data in which an inspection value or a measured value is recorded in time series can be displayed. The time-series data is displayed, for example, in the form of a graph G. Further, the data display screen 15 functions as an operation screen for inputting an instruction to associate a plurality of pieces of individual data corresponding to designated positions obtained by designating arbitrary points in the plurality of time-series data, as first information and second information on the medical care information. The client terminal 12 receives screen data 15A of the data display screen 15 from the medical care support server 11, and reproduces and displays the data display screen 15 on the basis of the screen data 15A.

The medical care support server 11 acquires the time-series data from the electronic medical chart server 16 or the image server 17 on the basis of a distribution request from the client terminal 12, generates the screen data 15A on the basis of the acquired time-series data, and distributes the generated screen data 15A to the client terminal 12 that is a request source.

The electronic medical chart server 16 includes an electronic medical chart database 16A (hereinafter referred to as a medical chart DB) in which the electronic medical chart is stored. The image server 17 has an image DB 17A in which a plurality of inspection images are stored, and is a so-called Picture Archiving and Communication System (PACS) server. The chart DB 16A and the image DB 17A are databases in which search can be performed based on a keyword, such as a patient ID.

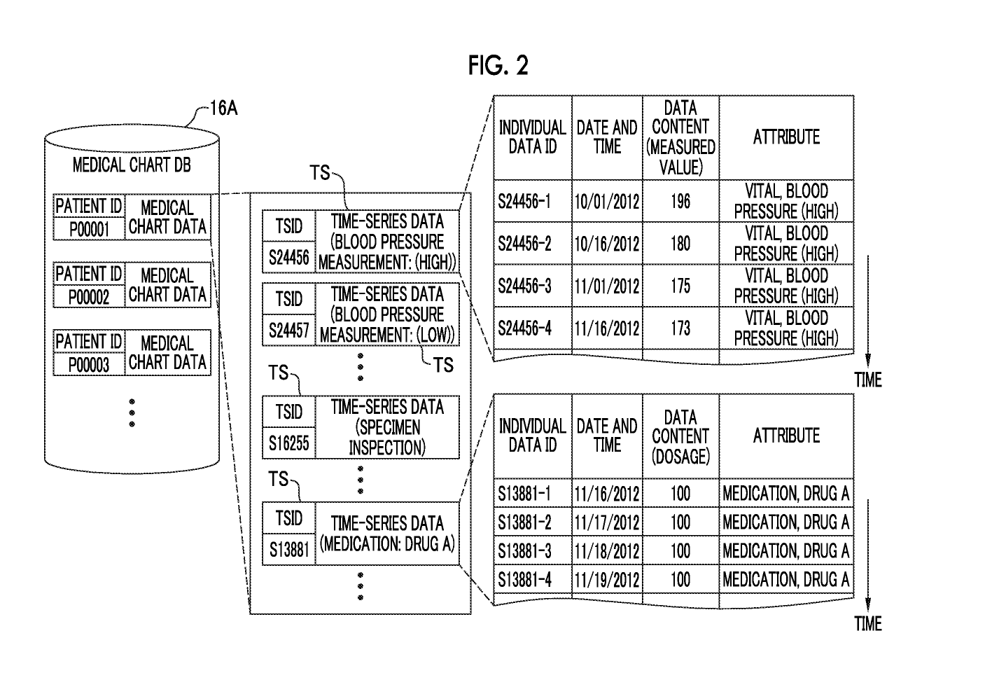

As illustrated in FIG. 2, in the chart DB 16A, a patient ID (P00001, P00002 . . . ) is assigned to the medical chart data in which medical care information on the patient is recorded, and stored in units of patients. The medical chart data includes time-series data TS as one piece of medical care information, in addition to basic patient information such as patient's name, date of birth, gender, and patient ID.

The time-series data TS is data indicating a transition of a condition of a patient and content of medical care performed on the patient. The transition of a condition of a patient refers to, for example, a temporal change in a measured value of a vital sign such as a heart rate, a pulse, blood pressure, or body temperature of a patient, or an inspection value of clinical inspection performed on a patient. The clinical inspection includes specimen inspection such as blood inspection or biochemical inspection, and physiological inspection such as electroencephalographic inspection. Time-series data indicating the transition of condition the patient is a data series of a plurality of measured values or inspection values acquired over time. Content of medical care performed on the patient includes content of therapy such as medication, surgery, or treatment, or content of medical interview. Time-series data indicating the content of the medical care performed on the patient is time-series indicating content of a plurality of medical cares performed over time.

The time-series data TS is, typically, data series including a plurality of items of individual data acquired in time series for each of the same medical care items, such as blood pressure measurement and medication, as elements. As shown in this example, assuming that time-series data TS is time-series data TS of the blood pressure measurement, a plurality of measurement values for which measurement date are different constitutes a plurality of items of individual data as an element of the time-series data TS. From the time-series data TS of the blood pressure measurement, it is possible to confirm a change over time in the patient's blood pressure. In this example, the time-series data TS of the blood pressure measurement is divided into blood pressure (high) and blood pressure (low), which are recorded as one item of time-series data TS.

In the time-series data TS of medication, in a case in which the same drug is divided and administered in a plurality of times for a period of time, a dosage of each time constitutes a plurality of items of individual data as an element of the time-series data TS. Since the individual data of the medication in this example is recorded continuously for several days from 2012 Nov. 16 and the dosage of each individual data is the same amount (“100”), it can be confirmed from the time-series data TS of the medication that the same amount of drug A is administered to a patient once daily for several days.

A record of one piece of individual data includes, for example, data items: an individual data ID, date and time, data content (for example, measured value, dosage, or inspection data), and attribute. Information on the date and time is measurement date and time in the case of the measured value, inspection date and time in the case of the inspection value, and date and time in the event that medication has been performed or date and time of prescription in the case of the dosage. In a case in which the individual data is recorded a plurality of times a day, time information is also necessary so as to distinguish the respective items of individual data from one another, but in a case in which an acquisition frequency of the individual data is smaller than or equal to once per day, date information may be sufficient. The individual data ID is identification information that is assigned to each item of the individual data so as to specify the individual data. In this example, the individual data ID is provided as an independent data item separate from the date and time information, but since the individual data ID may specify the individual data, information on the date and time rather than the individual data ID can be used as the individual data ID.

Further, since the medication may require a period until effects of the medication are expressed, for example, medication (taking a drug) over a predetermined period such as “taking drug by a predetermined amount in one day is continued for five days” may be instructed as one prescription. In this case, data of a prescription unit indicating content (a drug taking period and a dosage) of one prescription may be used as individual data. Date and time of this individual data is, for example, be prescription date and time.

The attribute is information assigned to classify data, and is information indicating a type of individual data. The attribute can also be used as a keyword for searching for the individual data. Further, since the individual data is an element of time-series data, the individual data has a meaning as information indicating a type of time-series data. Examples of the attribute include a name of the individual data, a category to which the individual data belongs, and a name of a medical care item corresponding to the individual data. In this example, as an attribute of individual data of blood pressure, a name of a measured value of “blood pressure (high)” is assigned, and a category “vital” is assigned since the blood pressure is one of vital signs. Further, since the measured value of the blood pressure is a numerical value, a type of data “numerical value data” can be assigned as an attribute or a category “measured value” distinguished from the “inspection value” can be assigned as an attribute. Further, a name “blood pressure measurement” of the medical care item can be assigned.

In the time-series data TS of medication, a name “medication” of the medical care item or a drug name “drug A” is assigned in the attribute. Further, as an attributes of medication, an administration method such as injection or taking may be assigned. The attribute may be automatically assigned according to content of input data by the electronic medical chart server 16, or may be assigned by manual input.

Further, content of medical interview is included in content of the medical care, in addition to content of treatment such as medication, but in the case of the medical interview, a medical interview record for each medical interview becomes individual data. A series of the individual data of the medical interview that is acquired in time series at different timings becomes time-series data of the medical interview. Further, a series of findings recorded a plurality of times by the doctor at the time of medical care are time-series data of findings.

IDs for identifying respective pieces of time-series data TS (“TSID”) such as “S24456” and “S24457” are assigned to the respective pieces of time-series data TS. Therefore, using the patient IDs, the time-series data IDs, and the individual data IDs, the medical chart data, the time-series data TS within the medical chart data, and the individual data within the time-series data TS can be specified and searched for.

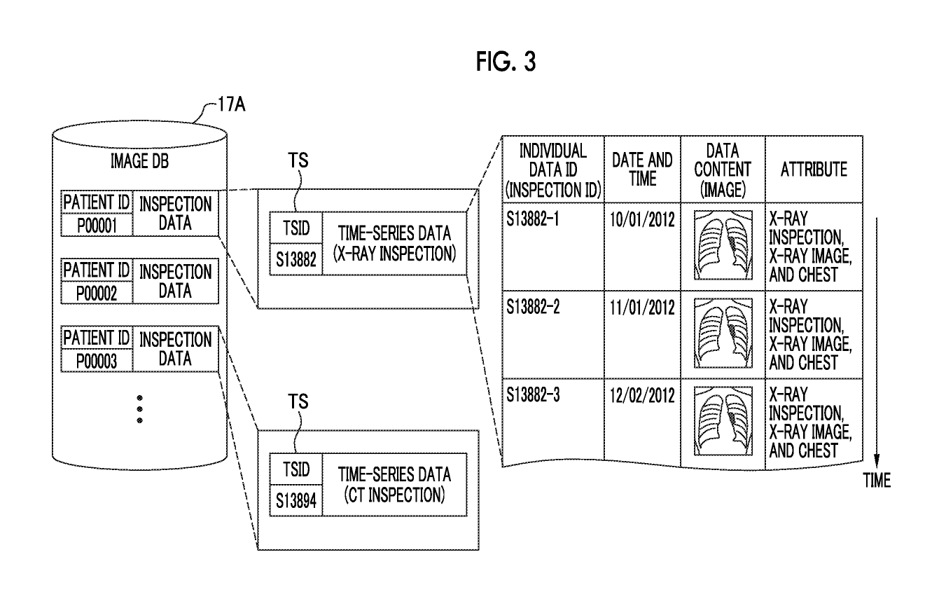

As illustrated in FIG. 3, inspection data including a plurality of inspection images captured in an image inspection such as an X-ray inspection or a CT inspection is stored in the image DB 17A. A patient ID is assigned to the inspection image, and the inspection image can be searched for using the patients ID. The image inspection may also be performed a plurality of times in medical care of one patient, as in a case in which progress observation is performed, and in this case, time-series data TS of the image inspection is acquired.

In the time-series data TS of the image inspection, the inspection image obtained by one image inspection becomes individual data. As an individual data ID, for example, an inspection ID is used. Since a plurality of tomographic images are acquired in one inspection in the case of the CT inspection, one piece of individual data includes a plurality of tomographic images. In the case of the X-ray inspection using a general X-ray imaging apparatus, since the number of X-ray images acquired in one inspection may be 1 or may be plural, the number of X-ray images in one piece of individual data may be 1 or may be plural. In an attribute of the individual data of the X-ray inspection, for example, information such as “X-ray inspection” indicating a type of inspection, “X-ray image” that is a type of image, and “chest” indicating an imaged part is assigned.

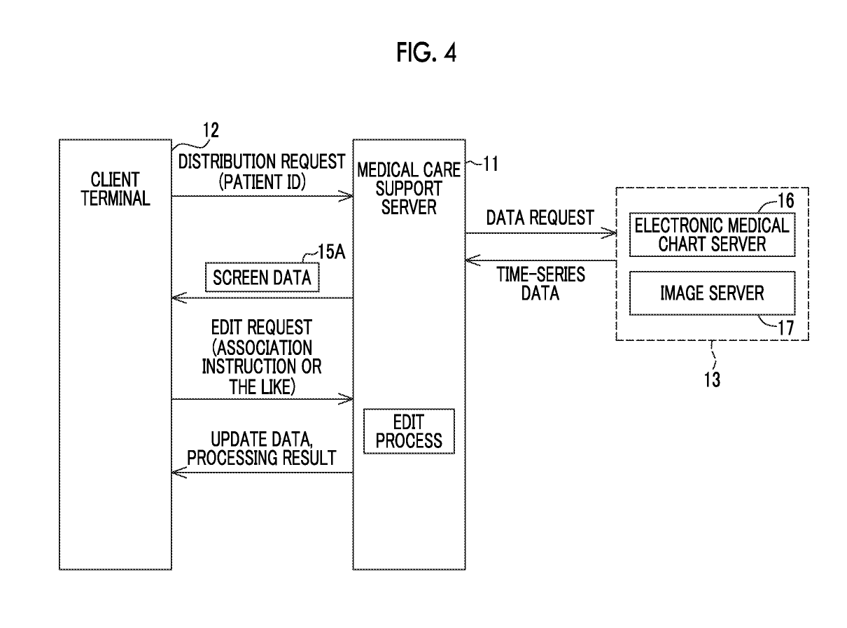

As illustrated in FIG. 4, the client terminal 12 receives the patient ID designated by an operation of a doctor, issues a distribution request including the designated patient ID, and transmits the distribution request to the medical care support server 11. Assuming that the medical care support server 11 receives the distribution request from the client terminal 12, the medical care support server 11 transmits a search request for time-series data TS to the electronic medical chart server 16 or the image server 17 using the patient ID as a search key. The electronic medical chart server 16 and the image server 17 search for each item of the time-series data TS corresponding to the patient ID from the chart DB 16A and the image DB 17A, and transmits the time-series data TS to the medical care support server 11. The medical care support server 11 generates the screen data 15A of the data display screen 15 on the basis of each item of the acquired time-series data TS, and distributes the screen data 15A to the client terminal 12 that is a request source for the distribution request.

In the data display screen 15, screen editing such as changing a screen layout or changing a display item to be displayed in the data display screen 15, such as the time-series data TS to be displayed, can be performed through an operation of the doctor. Further, in the data display screen 15, an information editing operation regarding the medical care information, such as association of the individual data in the plurality of items of displayed time-series data TS with each other or grouping of a set of items of associated individual data, or a search instruction according to a designated search condition, such as a keyword, can be performed.

Assuming that an operation instruction regarding screen editing, information editing, and search is input through the data display screen 15, the client terminal 12 issues an edit request or a search request according to the operation instruction, and transmits the edit request or the search request to the medical care support server 11. Assuming that the medical care support server 11 receives the edit request, the medical care support server 11 performs an editing process according to content of the edit request. In a case in which the edit request is screen editing, the medical care support server 11 generates the update data of the data display screen 15 as necessary, and distributes the update data to the client terminal 12 that is a request source. In the event that the edit request is an information edit request, the medical care support server 11 performs the association process or the grouping process and distributes a result of the process to the client terminal 12 that is a request source, as necessary. Further, assuming that the medical care support server 11 receives the search request, the medical care support server 11 performs the search process and distributes a search result as a processing result. Assuming that the client terminal 12 receives the update data or the processing result, the client terminal 12 performs update of the data display screen 15 based on the update data or a display of the processing result.

The medical care support server 11, the client terminal 12, the electronic medical chart server 16, and the image server 17 are configured by installing a control program such as an operating system or an application program such as a client program or a server program in a computer such as a personal computer, a server computer, or a workstation.

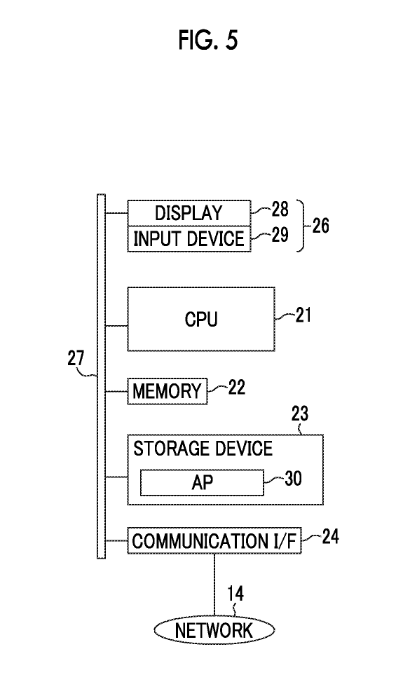

As illustrated in FIG. 5, a computer constituting each server 11, 16, or 17 or the client terminal 12 has the same basic configuration, and includes a central processing unit (CPU) 21, a memory 22, a storage device 23, a communication I/F 24, and an input and output unit 26. These are connected via a data bus 27. The input and output unit 26 includes a display (display unit) 28, and an input device 29 such as a keyboard or a mouse.

The storage device 23 is, for example, a hard disk drive (HDD), and a control program or an application program (hereinafter referred to as an AP) 30 is stored. Further, for example, a disk array in which a plurality of HDDs are connected and mounted is provided as a storage device 23 for a DB separately from the HDD that stores the program, in a server in which a DB is constructed. The disk array may be built into a main body of the server or may be provided separately from the main body of the server and connected to the main body of the server via a cable or a network.

The memory 22 is a work memory used for the CPU 21 to execute a process, and includes a random access memory (RAM). The CPU 21 loads a control program stored in the storage device 23 into the memory 22 and executes a process according to the program to control each unit of the computer. The communication I/F 24 is a network interface that performs transfer control with the network 14.

In the client terminal 12, a client program such as electronic medical chart software for performing viewing or editing of an electronic medical chart, or viewer software for performing viewing of inspection images or the data display screen 15 is installed as the AP 30. The viewer software may be, for example, dedicated software or may be a general-purpose WEB browser.

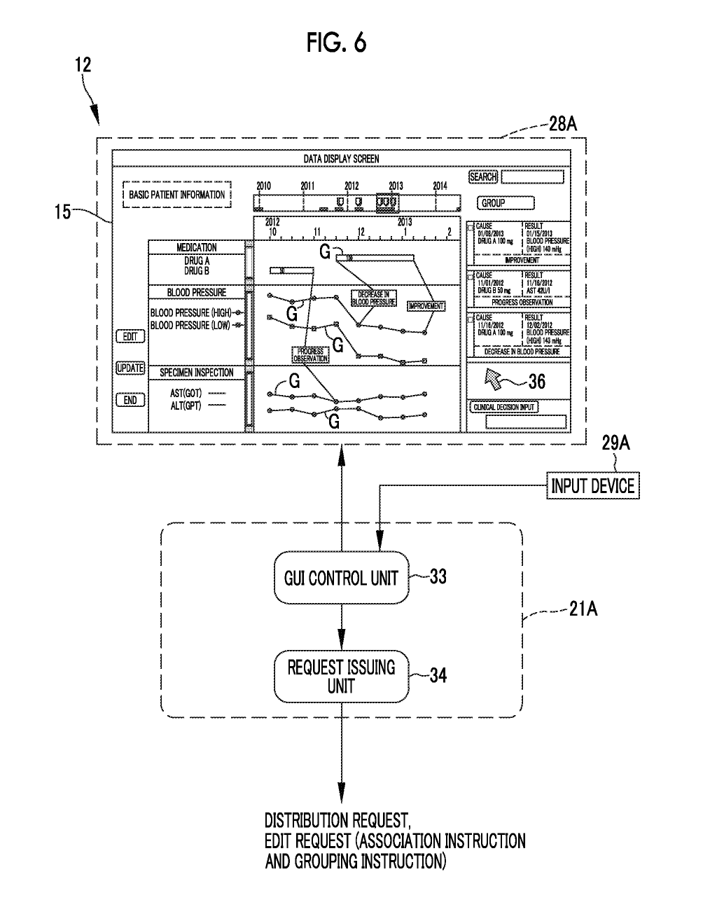

As illustrated in FIG. 6, assuming that the viewer software for displaying the data display screen 15 starts up in the client terminal 12, a start-up screen having an operation function using a graphical user interface (GUI) is displayed on the display 28A of the client terminal 12. The CPU 21A of the client terminal 12 functions as a request issuing unit 34 that issues various requests for the GUI control unit 33 and the medical care support server 11 in cooperation with the memory 22. A designation of the patient ID in the start-up screen or an operation of issuing a distribution request for the screen data 15A of the data display screen 15 is performed.

The screen data 15A includes, for example, data described in a markup language such as Extensible Markup Language (XML), and the data display screen 15 that is reproduced by the screen data 15A also has an operation function using a GUI. The GUI control unit 33 reproduces the data display screen 15 on the basis of the screen data 15A and displays the data display screen 15 on the display 28A. Further, the GUI control unit 33 receives an operation instruction from the input device 29A through the data display screen 15 such as a click operation of an operation button using a pointer 36 of a mouse, and performs a screen control according to the received operation instruction. The request issuing unit 34 issues a request to distribute the data display screen 15 of the designated patient ID or an edit request or a search request for the designated content according to the operation instruction received by the GUI control unit 33.

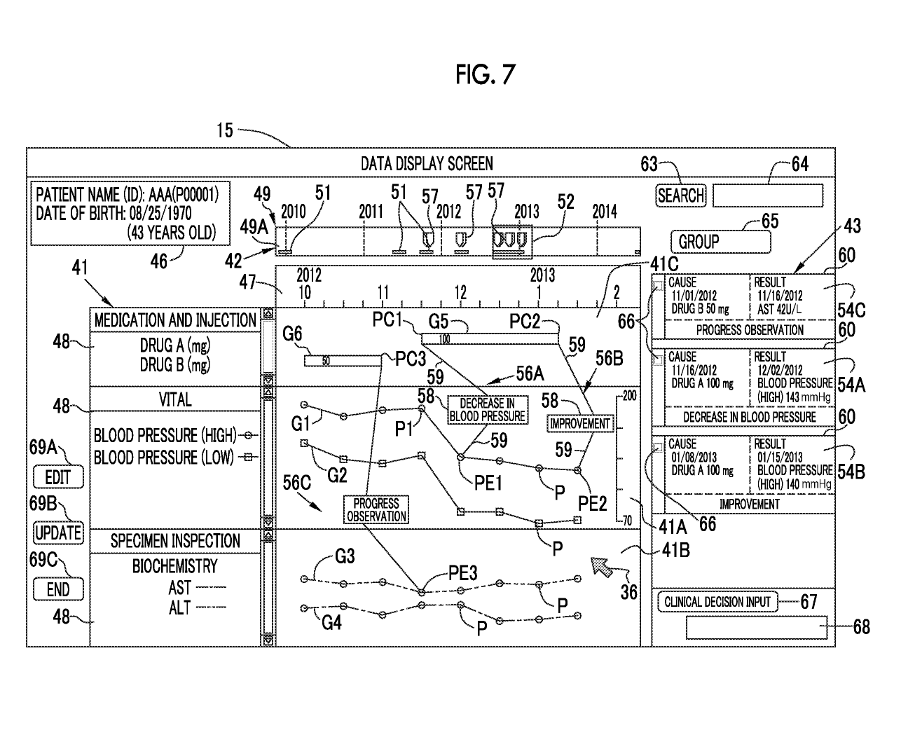

As illustrated in FIG. 7, the data display screen 15 includes a first display area 41, a second display area 42, a list display area 43, and a basic information display area 46. Basic patient information, such as a patient name, patient ID, and age is displayed in the basic information display area 46.

The first display area 41 is an area for displaying the time-series data TS (graph G). In the first display area 41, a time is assigned to a horizontal axis. The first display area 41 is divided into a plurality of sub-areas 41A to 41C in a vertical direction. A first time axis 47 of the first display area 41 is provided in an upper portion of the first display area 41. In the first time axis 47, information such as year, month and day, and a scale are arranged according to a set time scale. The first time axis 47 has a length corresponding to the first display period of the first display area 41, and also has a width in a vertical direction so that information can be displayed therein. In this example, the first display period is set to about four months from October 2012 to early February 2013. In the first time axis 47, a numeral indicating the year and the month of the four months corresponding to the first display period, and a scale at a predetermined interval between the months are displayed.

In the first display area 41, data in a range corresponding to the first display period in the time-series data TS is displayed in the form of a graph G (G1 to G6). The first display period can be changed by a screen scroll operation in the horizontal direction. By this screen scroll operation, display of the year and the month of the first time axis 47 is changed, and a display range of the time-series data TS is changed. In the screen data 15A sent in one distribution from the medical care support server 11, time-series data TS of a longer period than the first display period is included. Therefore, the changing of the display range of the time-series data TS can be performed without redistribution from the medical care support server 11 so long as the range is a received range. In a case in which a change exceeding the received range is performed on the display range of the time-series data TS, additional distribution of the time-series data TS is received from the medical care support server 11.

A plurality of time-series data TS acquired in the same period corresponding to the first display period are displayed in the respective sub-areas 41A to 41C. Accordingly, a plurality of items of time-series data TS of the same period of time are comparably displayed. Six items of time-series data TS of different types are displayed in the form of graphs G1 to G6 in the respective sub-areas 41A to 41C. The type of time-series data TS to be displayed in the respective sub-areas 41A to 41C can be changed by a setting. A type or a name of the time-series data TS, and an item display field 48 for displaying medical care items corresponding the time-series data TS are provided in each of the sub-areas 41A to 41C to the left of the respective sub-areas 41A to 41C.

In this example, the sub-area 41A of the second stage from the top is set as an area for displaying the time-series data TS corresponding to vital signs such as blood pressure, body temperature, respiration, and a heart rate. More specifically, as the time-series data TS of the vital signs, the graphs G1 and G2 indicating a transition of measured values of the blood pressure are displayed. The graph G1 is a graph of blood pressure (high), and the graph G2 is a graph of blood pressure (low). The graphs G1 and G2 are line graphs that connect the input points P of a plurality of measured values (individual data) acquired in time series. Further, a scale of the measured value extending in a vertical direction (a lower limit “70” and an upper limit “200” in this example) is provided in a right end in the sub-area 41A. In the item display field 48 of the sub-area 41A, “vital” is displayed as a name of a large classification of the medical care item, and a name of a measured value indicated by the graphs G1 and G2 of “blood pressure (high)” and “blood pressure (low)” is displayed.

Further, since a plurality of graphs G1 and G2 are displayed within one area in the sub-area 41A, for example, different types of lines on which shapes of the input points P are distinguished by a square or a circle are assigned to the respective graphs G1 and G2 so as to identify the graphs G1 and G2. Line type information indicating whether the graphs G1 and G2 indicate high or low blood pressure is also displayed in the item display field 48. Although only the blood pressure is displayed as a vital sign in this example, body temperature, heart rate, or the like may be displayed in the sub-area 41A, in addition to the blood pressure. In this case, it is preferable for the line types and colors of the graphs to be changed so that each graph can be identified. It should be understood that only one graph G may be displayed in one sub-area instead of the plurality of graphs G being displayed in one sub-area.

The third stage of sub-area 41B is set as an area for displaying time-series data TS of an inspection value of specimen inspection, and graphs G3 and G4 indicating a transition of the inspection value are displayed. The graphs G3 and G4 are, for example, inspection values of biochemistry inspection, which is one of specimen inspections, the graph G3 is an inspection value of AST (aspartate aminotransferase), and the graph G4 is an inspection value of ALT (alanine aminotransferase). The graphs G3 and G4 are line graphs that connect the input points P of a plurality of inspection values (individual data) acquired in times series, similar to the graphs G1 and G2. “Specimen inspection” as a name of a large classification of the medical care item, “biochemistry” as a name of a middle classification of the medical care item, and “AST” and “ALT” as a name of the inspection value indicated by the graphs G3 and G4 are displayed in the item display field 48 corresponding to the sub-area 41B. Further, line type information for identifying the graphs G3 and G4 are also displayed.

The first stage of the sub-area 41C is set as an area for displaying the time-series data TS of drug administration, such as medication or injection, and graphs G5 and G6 indicating a period in which drug administration has been performed are displayed. Graph G5 is a graph of drug A and graph G6 is a graph of drug B. In this example, since the dosage for both of drug A and drug B is constant over an entire period, the graphs G5 and G6 are displayed in the form of a bar graph extending straight in a horizontal direction. Assuming that the dosage is changed, the graphs G5 and G6 are changed in the vertical direction. A display indicating numerical values (“100” and “50”) of the dosage is inserted into the graphs G5 and G6. “Medication and injection” as a name of a large classification of the medical care item, “Drug A” as a drug name, “mg” as a unit of dosage, and the like are displayed in an item display field 48 corresponding to the sub-area 41C.

Further, although not illustrated, a plurality of thumbnail images are arranged along the time axis in a case in which the time-series data TS of the image inspection is displayed in the sub-area. Although the example in which the first display area 41 is divided into three sub-areas has been described in this example, the number of divisions is not limited to three, but may be two or may be three or greater. In a case in which there are the number of sub-areas equal to or greater than the number of sub-areas that can be simultaneously displayed in the first display area 41, a hidden sub-area may be able to be displayed by, for example, the screen scroll operation in the vertical direction. Further, it should be understood that the first display area 41 may not be divided.

The second display area 42 has a relatively longer time scale than the first display area 41, and a second time axis 49 of which the time scale is longer than the first time axis 47 is displayed in the second display area 42. The second time axis 49 has a display frame 49A having a width in a vertical direction in which information can be displayed therein, similar to the first time axis 47. In the second time axis 49, a numeral such as year, month, and day is displayed in an upper portion of the display frame 49A. A scale is displayed in each year inside the display frame 49A. The numeral of year, month and day, and the scale are arranged according to a set time scale.

A length of the second time axis 49 corresponds to the second display period of the second display area 42. The second display period has a longer time scale than the first display period of the first display area 41, and the first display area 41 and the second display area 42 in the data display screen 15 have substantially the same widths. Therefore, for a period of a part in the second time axis 49, detailed display can be performed in the first display area 41.

In FIG. 7, time-series data TS (graph G) corresponding to a part of the second display period is displayed in the first display area 41. In this example, the first display period is set to about four months from October 2012 to early February 2013, and the second display period is set to about four and a half years from 2010 to a first half of 2014 including the first display period of four months. The first display period and the second display period can be changed by a setting.

A data presence indicator 51 indicating that there is the time-series data TS in the second display period is displayed within the display frame 49A of the second time axis 49. Since the presence of the time-series data TS indicates that any medical care has been performed, the data presence indicator 51 also functions as an indicator indicating a day or a period in which the medical care has been performed. The data presence indicator 51 is, for example, a bar-shaped indicator extending in the direction of the second time axis 49. Further, a period indicator 52 is displayed in the display frame 49A.

The period indicator 52 is an indicator indicating a period to which the first display period of the first display area 41 corresponds on the second time axis 49. A width of the period indicator 52 corresponds to a width of the first display period in the time scale of the second time axis 49. In this example, since the first display period is about four months, the width of the period indicator 52 is a width of about four months in the time scale of the second time axis 49. Further, the period indicator 52 also functions as an operation portion for changing the first display period of the first display area 41. The period indicator 52 has an operation portion slidable on the second time axis 49. Assuming that the period indicator 52 is designated by the pointer 36 and a slide operation is performed, the first display period of the first display area 41 is also changed. For example, assuming that the period indicator 52 is moved from a position of 2013 to a position of 2012 in the second time axis 49 by the slide operation, the first display period displayed in the first display area 41 is changed from 2013 to 2012. Further, in the event that the period indicator 52 is moved to a position in which there is the data presence indicator 51, the series data TS corresponding to the period of the data presence indicator 51 can be displayed in the first display area 41.

Further, in the data display screen 15, an association instruction and a grouping instruction can be input as information editing operation instructions. The association instruction is an instruction to designate at least two points in the time-series data TS displayed in the first display area 41, and associate a plurality of first information and second information corresponding to at least two designated positions including the first and second designated positions. For example, the first designated position is designated on one graph G, and the second designated position is designated on the other graph G.

In the case of the graphs G1 to G4, at least any one of a plurality of input points P of individual data may be designated as the designated position. In a case in which the input point P is designated, the individual data corresponding to the input point P of the designated position is designated as the first information or the second information. In the case of the graphs G5 and G6, at least any one point on the graphs G5 and G6 can be designated. Further, in the case of the graphs G5 and G6, individual data corresponding to the designated position is designated as the first information or the second information. Further, in the case of the graphs G5 and G6, since it is shown that continuous medication is performed over a predetermined period, the entire medication period (both of the graphs G5 and G6) can also be designated as the designated position. In this case, the entire time-series data TS corresponding to the graphs G5 and G6 is designated as the first information or the second information. In this example, the respective items of time-series data TS corresponding to the graphs G5 and G 6 correspond to the first time-series data and the second time-series data.

Assuming that an association instruction for the first information and the second information is input in the data display screen 15, the first information and the second information are associated with each other, and one piece of set information including a set of first information and second information 54 is created. Further, the set information 54 is displayed in the list display area 43 in the data display screen 15. Further, assuming that the association is performed, the association indicator 56 indicating that the first information and the second information are associated with each other is displayed in the first display area 41. The doctor can use such an association function in a case in which a causal relationship between the first information and the second information is ascertained. Causal relationship information indicating that one of the first information and the second information corresponds to the cause and the other corresponds to the result is included in the set information 54.

In the data display screen 15 of this example, three pieces of set information 54A to 54C of which the association has been performed are displayed in the list display area 43, and association indicators 56A to 56C corresponding thereto are displayed in the first display area 41. In such an example, the association will be described in greater detail.

For example, it can be seen from the graph G1 of blood pressure (high) that a blood pressure transitions to a relatively high state before an input point P1, suddenly decreases between the input point P1 and PE1, and is stabilized at a relatively low state after PE1. Meanwhile, it can be seen from the graph G5 of medication (drug A) that medication of drug A starts at the same time as the input point P1 at which the blood pressure starts to decrease. In such a case, a causal relationship between the medication start and the decrease in blood pressure, such as a result of the decrease in blood pressure due to a cause of start of the medication of drug A, can be confirmed. In a case in which the doctor has made such a decision, the medication start position of the graph G5 is designated as the cause position PC1 corresponding to the cause, the position at which the decrease in blood pressure occurs in the graph G1 is designated as the result position PE1 corresponding to the result, and the association instruction is input. Accordingly, respective items of individual data of a “dosage of drug A” and a “measured value of blood pressure (high)” corresponding to the two designated positions are associated as the first information and the second information, and one piece of set information 54A including both as a set is created. In the set information 54A, causal relationship information in which the “dosage of drug A” corresponds to a cause, and a “measurement position of blood pressure (high)” corresponds to a result is included.

Further, in the first display area 41, an association indicator 56A indicating that the cause position PC1 and the result position PE1 are associated is assigned at the cause position PC1 and the result position PE1. The association indicator 56A is an indicator in a link form in which the association indicator 56A includes a tag 58 and a connection line 59 connecting two designated positions. The tag 58 includes an object in which a comment can be input and displayed. The comment indicates, for example, findings of the doctor regarding the cause and the result, and is input as text data. Findings “decrease in blood pressure” of the doctor is input as a comment to the tag 58 of the association indicator 56A and displayed.

A comment “decrease in blood pressure” input to the tag 58 is also added to the set information 54A. In the list display area 43, “dosage of drug A” (cause), “measured value of blood pressure (high)” (result), and “decrease in blood pressure” (comment) included in the set information 54A are displayed in the display field 60 corresponding to the set information 54A. The display field 60 is divided into small sections for displaying the cause, the result, and the comment, respectively, and is adapted so that each piece of information can be confirmed at a glance.

Further, it is recognized that the blood pressure is stabilized as a low value and improved in the graph G1 of blood pressure (high) in the same period of time as an end of the medication period of the graph G5 of medication (drug A). In such a case, the end of the medication period of the graph G5 is designated as the cause position PC 2, a position at which the improvement has been confirmed is designated as a result position PE2 in the graph G1 of the blood pressure (high), and the association is performed. Accordingly, set information 54B including a set of “dosage of drug A” corresponding to the cause position PC2, “measured value of the blood pressure (high)” corresponding to the result position PE2, and the comment “improvement” is created. The set information 54B is displayed in the list display area 43. Further, the association indicator 56B is assigned at a designated position of the first display area 41. The association indicator 56B is in a link form, similar to the association indicator 56A, each position is connected by the connection line 59, and a comment “improvement” is displayed in the tag 58 of the association indicator 56B.

Similarly, an end of the medication period of the graph G6 of dosage (drug B) is designated as a cause position PC3, one point of the graph G3 of “AST” is designated as a result position PE3, and association is performed. Set information 54C including a set of “dosage of drug B” of the cause position PC3 and “inspection value of AST” of the result position PE3 is created. The set information 54C is also displayed in the list display area 43, and an association indicator 56C is assigned at the designated position of the first display area 41. The association indicator 56C also is in the same link form as those of association indicators 56A and 56B, and a comment “progress observation” is input to the tag 58 and displayed. This comment is also included in the set information 54B.

Assuming that such association is performed, the association indicator 56 is displayed in the first display area 41. Through the association indicator 56, it is possible to simply ascertain a causal relationship between the two positions in the plurality of associated items of time-series data TS. Further, assuming that the association indicator 56 is assigned, a corresponding indicator 57 is assigned at a corresponding position that temporally corresponds to the association indicator 56 in the second display area 42. The corresponding indicator 57 is an indicator indicating whether there is the association indicator 56 at a certain position in the second time axis 49. The corresponding indicator 57 is assigned at positions corresponding to the two designated positions of the association indicator 56, and displayed in the display frame 49A together with the data presence indicator 51.

In the second time axis 49, the corresponding indicator 57 is not only displayed in a period corresponding to the first display period in which there is the period indicator 52, but also displayed at a position outside the first display period. In this example, the first display period is a period from October 2012 to early February 2013 and the period indicator 52 is also displayed at the position corresponding to that period, but in the second time axis 49, the corresponding indicator 57 is also displayed at a position corresponding to the outside of the first display period such as 2011 or a first half of 2012. Therefore, it is possible to confirm an approximate period of time in which there is the association indicator 56 in the first display period displayed in the first display area 41, as well as in the outside of the first display period.

Further, in the data display screen 15, assuming that any one of the corresponding indicators 57 in the second display area 42 is selected, the first display period of the first display area 41 is changed to a display period including the association indicator 56 corresponding to the selected corresponding indicator 57. As described above, the first display period of the first display area 41 can also be changed by an operation of the period indicator 52 or can be changed by a selection operation of the corresponding indicator 57.

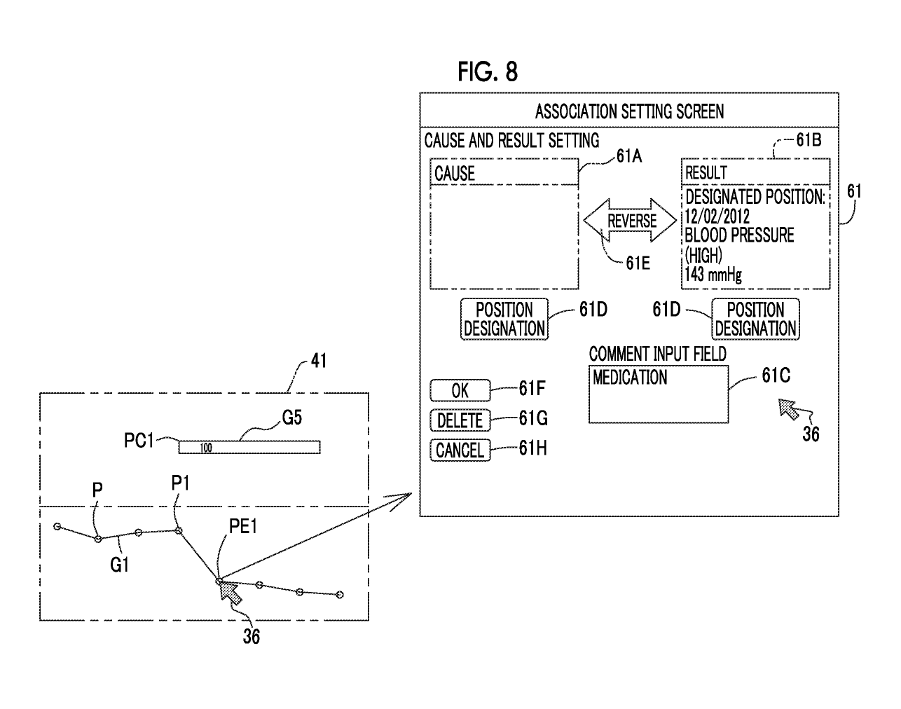

An input of the association instruction is performed, for example, in the following procedure. First, an arbitrary position on the graph G is designated by the pointer 36 and a click operation is performed. Assuming that the click operation is performed, an association setting screen 61 illustrated in FIG. 8 is opened on the data display screen 15. In the association setting screen 61, information display fields 61A and 61B in which the first information and the second information on the cause position and the result position are displayed, a comment input field 61C, a position designation button 61D, a reverse button 61E, an OK button 61F, a deletion button 61G, and a cancel button 61H are provided.

In the information display field 61A and the information display field 61B, the individual data corresponding to the cause position and result position are displayed as the first information and the second information. Since the input point P of the graph G1 corresponds to a measured value of the blood pressure (high) in a case in which the input point P on the graph G1 is designated, for example, a name (“blood pressure (high)”) of the measured value, measurement date (“2012/12/02”), and a measured value (“143”) are displayed in the information display field 61A. In this example, since the result position PE1 is designated, the individual data of the result position PE1 is displayed.

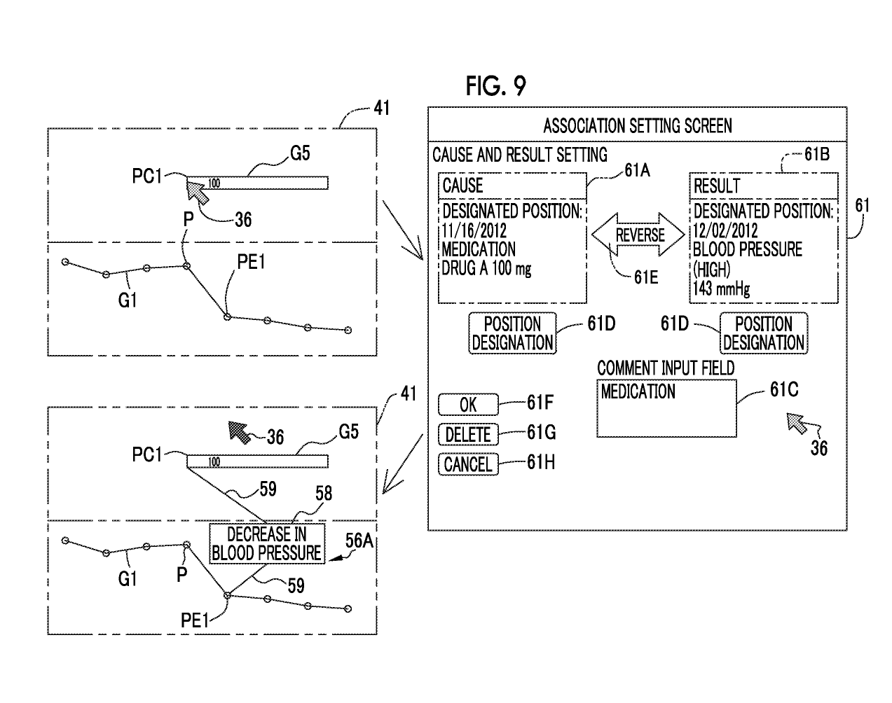

In a case in which only one of the cause position and the result position is specified, information is displayed in only one of information display fields 61A and 61B. In this example, for example, the information of the result position is displayed in the information display field 61B. Assuming that a position designation button 61D is operated, another designated position can be designated. Assuming that another point on the time-series data TS is designated by the pointer 36, information of another designated position is displayed as illustrated in FIG. 9. In this example, since the cause position PC1 of the graph G5 is designated, information of individual data regarding the medication of the cause position PC1 is displayed. A reverse button 61E is an operation button for switching between the positions by reversing the cause position and the result position.

Thus, the information display field 61A corresponds to the cause, and the information display field 61B corresponds to the result. Which of the cause and the result to which the two pieces of information correspond is identified according to which of the information display fields 61A and 61B to which two pieces of associated information are input. The identified information is set as causal relationship information. The causal relationship information may be information on an input order of the two pieces of information, such as first input information corresponding to the cause and the second input information corresponding to the result.

A comment input field 61C is an input field for inputting a comment such as “decrease in blood pressure”, “improvement”, and “progress observation” which are added to the set information 54. An OK button 61F is an operation button for inputting the association instruction. Assuming that the OK button 61F is operated, the GUI control unit 33 instructs the request issuing unit 34 to issue the association instruction with content set in the association setting screen.

The deletion button 61G is an operation button for deleting the once created set information 54. For example, in a case in which the set information 54 has already been created, assuming that one piece of set information 54 in the list display area 43 is designated with the pointer 36 and a click operation is performed, the association setting screen 61 is open. Assuming that the deletion button 61G is operated at this time, the created set information 54 is deleted. The cancel button 61H is an operation button for canceling content of an operation performed in a state in which the association setting screen 61 is open. Assuming that the cancel button 61H is operated, return to the state before the association setting screen 61 is open occurs.

Assuming that the input of such an association instruction is performed, the request issuing unit 34 issues an information edit request including the association instruction. The information edit request is transmitted to the medical care support server 11. The medical care support server 11 executes the association process to create and store the set information 54. The medical care support server 11 distributes the created set information 54 as a processing result to the client terminal 12.

In FIG. 7, a search button 63 and a keyword input field 64 are provided in the data display screen 15, and the created set information 54 can be searched for by the keyword. The set information 54 extracted by the search is displayed in the list display area 43. As illustrated in FIG. 2, the individual data includes the information on the attribute. Since the set information 54 includes the individual data, keyword search of the set information 54 can be performed using the attributes of the individual data.

For example, assuming that “blood pressure” is input as a keyword to the keyword input field 64 and the search button 63 is operated, a search request is transmitted to the medical care support server 11, and a search process for the set information 54 is executed in the medical care support server 11. The set information 54 including “blood pressure” as the attribute is extracted, and only the extracted set information 54 is displayed in the list display area 43.

Further, in the list display area 43, for example, the set information 54 is sorted in an order of acquisition date of the individual data and displayed. A display order of the set information 54 can also be changed, for example, to a creation order of the set information 54, in addition to the acquisition date of the individual data.

Displays of the list display area 43 and the first display area 41 are in conjunction with each other. Assuming that the set information 54 extracted through search is displayed in the list display area 43, the display of the first display area 41 is also changed to the display of only the association indicator corresponding to the extracted set information 54. Accordingly, it is possible to simply confirm the set information 54 or the association indicator 56 desired to be confirmed by the doctor. Conversely, in the event that the display of the first display area 41 is changed, the display of the list display area 43 is also changed. For example, in a case in which the first display period of the first display area 41 is changed by a screen scroll operation, the association indicator 56 to be displayed is also changed. Therefore, the set information 54 of the list display area 43 is also changed in conjunction with the change of the association indicator 56 displayed in the first display area 41.

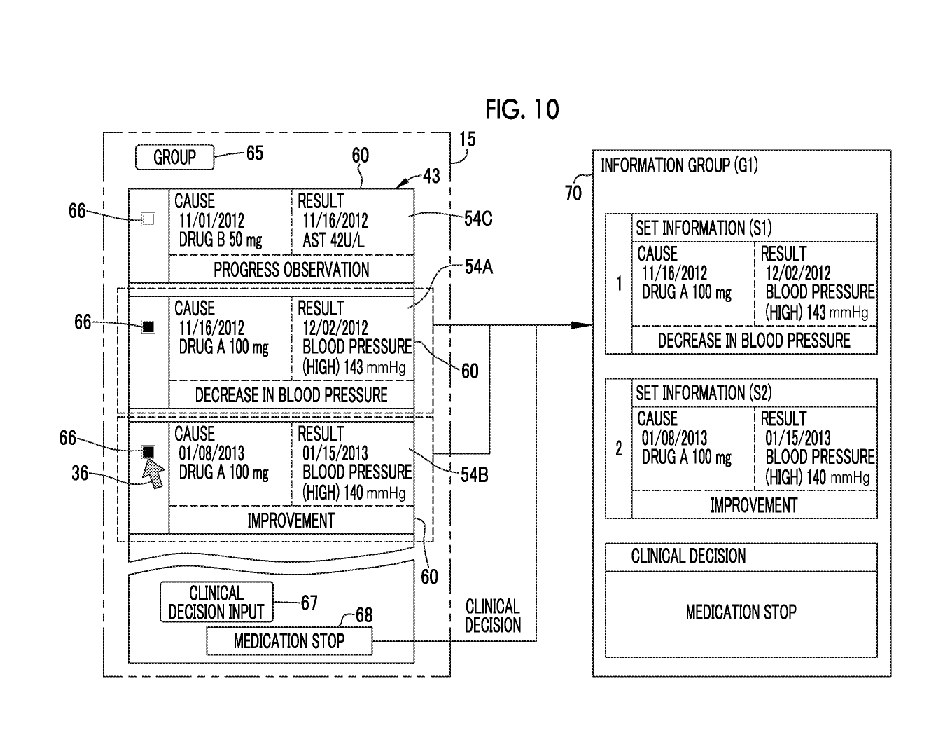

Further, the information editing operation instruction that can be input in the data display screen 15 as described above includes a grouping instruction, in addition to the association instruction. The grouping instruction is an instruction for grouping one or more pieces of created set information 54 in units of clinical decision and creating the information group 70 illustrated in FIG. 10. The clinical decision is a decision based on the medical care information for next treatment or therapy content to be performed on the patient, as described above.

In FIG. 10, in a case in which the causal relationship between the medication of drug A and the decrease in blood pressure has been observed as shown in the set information 54A and the set information 54B, the doctor determines whether to continue the medication in order to decrease the blood pressure or to stop the medication since the blood pressure has decreased to a target value, in the clinical decision. In the information group 70 having group ID “G1” in this example, “medication stop” is included as content of the clinical decision.

Thus, information in which the cause and the result form a set, such as the set information 54, serves as a basis for clinical decision. The clinical decision may be based on one causal relationship or may be based on a plurality of causal relationships that are logically collected. Assuming that one causal relationship or a group of causal relationships serving as the basis for clinical decision is obtained, it is possible to recognize the decision process of the doctor. The information group 70 is an information group obtained by collecting at least one piece of set information 54 serving as a basis of each clinical decision in a unit of such clinical decision.

A grouping button 65 is provided over the list display area 43, and a check box 66 is provided in each display field 60 of the set information 54. For example, assuming that the grouping button 65 is clicked once with the pointer 36, selection information of the set information 54 which is a grouping target is allowed to be input. In this state, the check box 66 is checked by a click operation of the pointer 36, the set information 54 is selected. Assuming that the checked check box 66 is clicked once more, the check is released and the selected set information 54 is canceled. Assuming that the grouping button 65 is clicked again, the GUI control unit 33 instructs the request issuing unit 34 to issue a grouping instruction including the selection information of the set information 54. The group instruction is transmitted to the medical care support server 11 as an information edit request.

Further, a clinical decision input button 67 and an input box 68 are provided below the list display area 43. Text data indicating the content of the clinical decision of the doctor is input to the input box 68. The clinical decision input button 67 is a button for adding the text data in the input box 68 as the content of the clinical decision to the information group 70. The content of the clinical decision may be selected from a list, instead of a direct input of the text data. Assuming that the clinical decision input button 67 is clicked in a state in which the set information 54 is allowed to be input, the content of clinical decision is added to the grouping target, in addition to the set information 54.

Since the created information group 70 shows a causal relationship or a group of causal relationships which serve as a basis of the clinical decision, the information group 70 shows a determination process of the doctor collecting the causal relationships logically. Therefore, the information group 70 can be used later to verify whether the determination process of the doctor is appropriate. Further, such an information group 70 has a value as an example of disease including determination know-how of the doctor. Therefore, the information group 70 can also be used as a past example of disease.

Further, after the information group 70 is created, the created information group 70 can be displayed in the list display area 43 so that the created information group 70 is viewed. In this case, the set information 54 in the displayed information group 70 can be added or deleted through a check operation of the check box 66. In a case in which the update of the information group 70 has been performed, a grouping instruction according to the update content is transmitted to the medical care support server 11.

In FIG. 7, an edit button 69A, an update button 69B, and an end button 69C are provided to the left of the first display area 41 on the data display screen 15. The edit button 69A is an operation button for performing screen editing of the data display screen 15. Assuming that the edit button 69A is operated, for example, an edit menu screen (not illustrated) for instructing the screen editing pops up. Screen editing items include, for example, a setting of a display period or a time scale of the first display area 41 and the second display area 42, and a setting of the number of divisions of sub-areas of the first display area 41. Further, there is a setting of display items such as the time-series data TS displayed in each sub-area or information displayed in areas other than the item display field 48. A screen layout may be changed. For example, the display positions of the first display area 41 and the second display area 42 are reversed. Further, a menu item for assigning the association indicator 56 may be displayed in the edit menu screen.

Assuming that the screen editing is instructed by the editing menu screen, the request issuing unit 34 issues a screen edit request according to designated content, and the screen edit request is transmitted to the medical care support server 11.

The update button 69B is an operation button for updating the data display screen 15. In a case in which any screen editing instruction is input at the point in time at which the update button 69B is operated, the request issuing unit 34 issues a screen edit request including the input screen editing instruction assuming that the update button 69B is operated. Assuming that there is no screen editing instruction, the request issuing unit 34 issues a distribution request to reload the screen data 15A of the data display screen 15 in an editing state at that point in time. The end button 69C is an operation button for ending the data display screen 15.

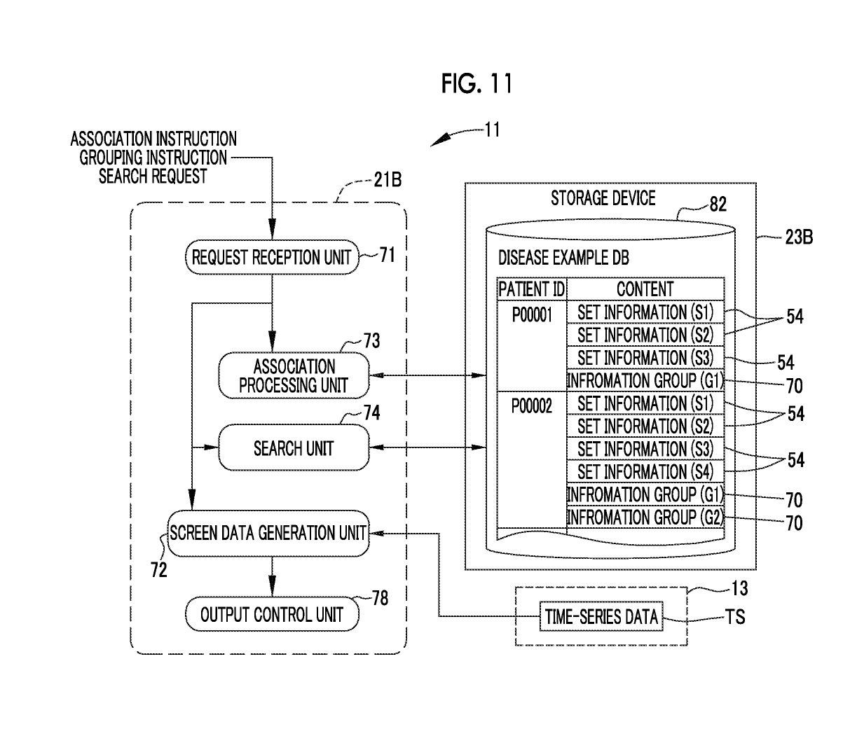

As illustrated in FIG. 11, a medical care support server program is installed as an AP 30 in the medical care support server 11. Assuming that the program is executed, the CPU 21B of the medical care support server 11 functions as a request reception unit 71, a screen data generation unit 72, an association processing unit 73, a search unit 74, and an output control unit 78 in cooperation with the memory 22.

The request reception unit 71 receives various requests from the client terminal 12. In a case in which the request reception unit 71 receives a distribution request or a screen edit request, the request reception unit 71 inputs the received request to the screen data generation unit 72. Further, the request reception unit 71 is a reception unit which receives an association instruction, a grouping instruction, and a search request. In a case in which the request reception unit 71 receives an information edit request including the association instruction or the grouping instruction, the request reception unit 71 inputs the received request to the association processing unit 73. Further, in a case in which the request reception unit 71 receives the search request, the request reception unit 71 inputs the search request to the search unit 74.

The screen data generation unit 72 generates the screen data 15A of the data display screen 15 for displaying the time-series data TS regarding the patient ID designated in the distribution request on the basis of the input distribution request. The screen data 15A is XML data for WEB distribution, as described above. The screen data generation unit 72 edits the screen data 15A on the basis of content of the screen edit request.

The association processing unit 73 creates one piece of set information 54 including a set of first information and second information that have been designated, on the basis of the association instruction, and groups one or more pieces of set information 54 in units of clinical decision to create the information group 70. In a case in which content of the clinical decision is input, the association processing unit 73 adds the content of clinical decision to the information group 70. The created set information 54 and the created information group 70 are stored in the storage device 23B in the medical care support server 11. A disease example database (hereinafter referred to as a disease example DB) 82 is created in the storage device 23B. As described above, the set information 54 or the information group 70 is stored as a disease example in the disease example DB 82 since the set information 54 or the information group 70 has a value as the disease example. In the disease example DB 82, the set information 54 or the information group 70 is stored in units of patients.

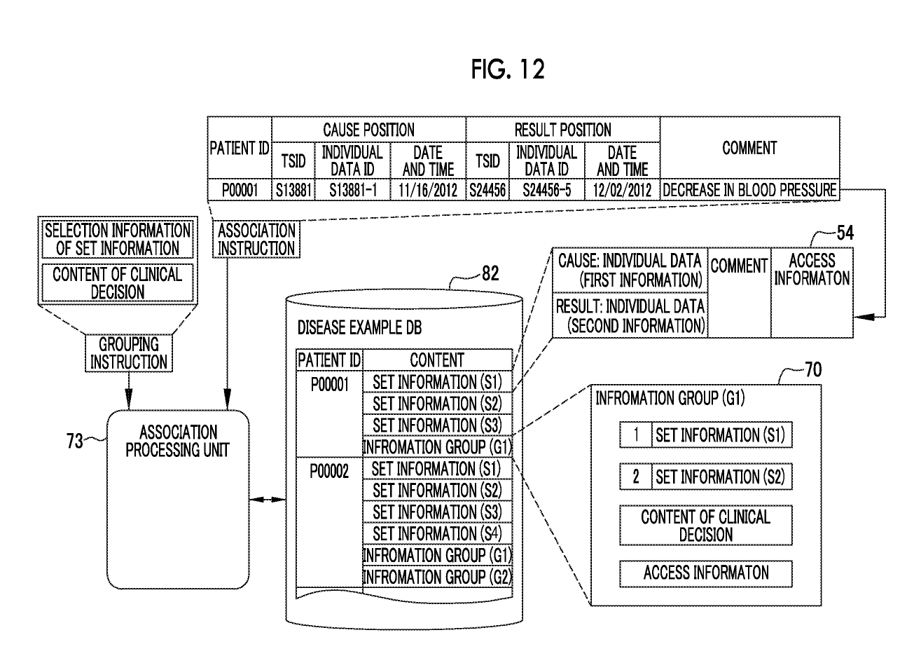

As illustrated in FIG. 12, in the association instruction, information on the cause position and the result position and an input comment are included corresponding to the content set in the association setting screen 61, in addition to the patient ID. Respective pieces of information of the cause position and the result position includes information of an TSID of the time-series data TS, an individual data ID, and date and time. The association processing unit 73 forms a set of respective items of individual data of the cause position and the result position as the first information and the second information, and adds a comment and access information to this set to create one piece of set information 54. Since the causal relationship information indicating which item of individual data corresponds to the cause and the result is included in the association instruction, the causal relationship information is also recorded in the set information 54.

The access information of the set information 54 is information on date and time at which the set information 54 is accessed through the data display screen 15 of the client terminal 12. In the access information, creation date and time at which the set information 54 has been newly created and stored, date and time at which the created set information 54 is distributed to the client terminal 12 and displayed on the data display screen 15, viewing date and time at which the created set information 54 is selected with the pointer 36 in the list display area 43 and viewed, date and time at which content has been updated, or the like is included.

Further, selection information of the set information 54 that is a grouping target, and content (for example, text data) of the clinical decision are included in the grouping instruction. The association processing unit 73 specifies the selected set information 54 in the disease example DB 82, and creates the information group 70 in which the specified set information 54 and the content of clinical decision are collected. In the information group 70, access information is included in addition to the set information 54 and the content of clinical decision. In the access information of the information group 70, creation date and time at which the information group 70 has been newly created and stored, date and time at which the created information group 70 is distributed to the client terminal 12 and displayed on the data display screen 15, viewing date and time at which the information group 70 displayed in the data display screen 15 is selected with the pointer 36 and viewed, date and time at which content has been updated, or the like is included. Further, in the access information of the information group 70, date and time at which the set information in the information group 70 has been added or deleted is also recorded.

By recording such access information, it is possible to sort the display order of the set information 54 in the information group 70. For example, assuming that the order of the creation date and time or the viewing date and time is recorded, it is possible to sort the set information 54 in a creation order or a viewing order. In a process of performing the clinical decision, the order of creation of the set information 54 or the order of viewing may briefly indicate a decision process in which the doctor logically collects the causal relationships. By sorting the set information 54 in the order of creation or the order of viewing, it is possible to confirm such a decision process. In FIG. 12, numbers “1” and “2” are assigned to two pieces of set information 54 in the information group 70, and indicate a display order of each piece of set information 54 that have been sorted. Assuming that the set information 54 is sorted in the order of creation, the set information 54 having an ID of “S1” is first displayed, and the set information 54 having an ID of “S2” is second displayed.

In FIG. 11, the search unit 74 searches for the set information 54 or the information group 70 in the disease example DB 81 on the basis of the keyword included in the search request, and outputs a result of the search. The output control unit 78 performs control to distribute the screen data 15A or the update data generated by the screen data generation unit 72 and the processing result of the association processing unit 73 and the search unit 74 to the client terminal 12 that is a request source. The client terminal 12 displays the data display screen 15 on the display on the basis of the received screen data 15A or the received update data. In the client terminal 12, the processing result is displayed.

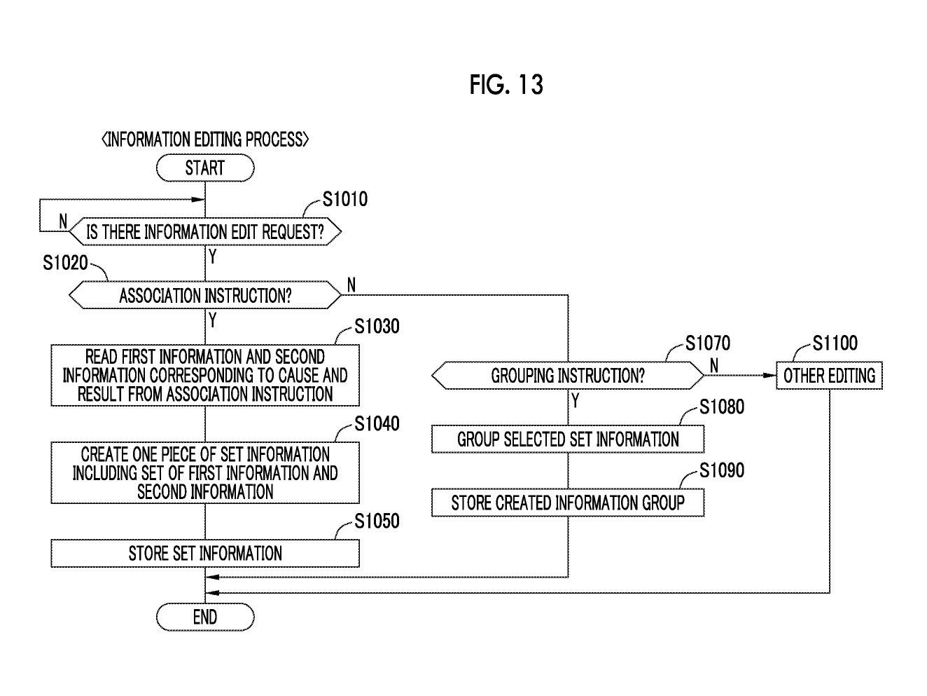

Hereinafter, an operation of the above configuration will be described with reference to FIG. 13. In the event that the data display screen 15 is displayed, the viewer software starts up in the client terminal 12. A patient ID is designated by the doctor, and a distribution request is issued. Assuming that the medical care support server 11 receives the distribution request, the medical care support server 11 extracts the patient ID included in the distribution request and acquires the time-series data TS corresponding to the designated patient ID from the server group 13. The medical care support server 11 generates the screen data 15A on the basis of the acquired time-series data TS and distributes the generated screen data 15A to the client terminal 12. The client terminal 12 reproduces the data display screen 15 on the basis of the received screen data 15A and displays the data display screen 15 on the display.

In the first display area 41 of the data display screen 15, the time-series data TS of the patient is displayed. The doctor confirms a causal relationship between a plurality of items of time-series data TS, designates the cause position and the result position in the time-series data TS with the pointer 36 assuming that the causal relationship is ascertained, and inputs the association instruction. Further, in a case in which the doctor has made the clinical decision regarding next treatment or therapy content to be performed on the patient on the basis of the causal relationship between a plurality of items of time-series data TS, the set information 54 serving as a basis of the clinical decision is grouped. Assuming that the set information 54 is grouped, the grouping button 65 is clicked and the selection information of the set information 54 is allowed to be input. Assuming that the set information 54 is selected by the check box 66 in the list display area 43 and the clinical decision is input to the input box 68, the clinical decision input button 67 is clicked. In this state, assuming that the grouping button 65 is operated, the grouping instruction is input. The group instruction and the association instruction are transmitted to the medical care support server 11 as an information edit request.

In the medical care support server 11, the request reception unit 71 waits for the information edit request (S1010). Assuming that the request reception unit 71 receives the information edit request (Y in S1010), the request reception unit determines whether the information edit request is an association instruction or a grouping instruction (S1020 and S1070). In a case in which the information edit request is the association instruction (Y in S1020), the association processing unit 73 reads the first information and the second information corresponding to the cause and the result from the association instruction (S1030), and creates one piece of set information including a set of first information and second information (S1040). The association processing unit 73 stores the created set information 54 in the storage device 23B (S1050). The set information 54 in the storage device 23B is stored in the disease example DB 82.

On the other hand, in a case in which the information edit request is determined to be the grouping instruction (Y in S1020 and N in S1070), the association processing unit 73 reads the selection information from the grouping instruction, groups the selected set information 54, and creates the information group 70 (S1080). Assuming that content of the clinical decision is included, the content of the clinical decision is also added to the information group 70. The association processing unit 73 stores the created information group 70 in the storage device 23B (S1090). In the storage device 23B, the information group 70 is stored in the disease example DB 82.

Since the set information 54 indicates a causal relationship in a plurality of pieces of medical care information, it is possible to simply ascertain a causal relationship by confirming the set information 54. Further, since the information group 70 indicates the causal relationship or the decision process of doctor who logically collects the causal relationship, it is possible to simply ascertain the causal relationship serving as the basis of the clinical decision or a group of causal relationships by confirming the information group 70. Further, by creating such set information 54 or information group 70, it is possible to accumulate useful information serving as the basis of the clinical decision. Since the set information 54 or the information group 70 indicates the information serving as the basis of the clinical decision, the set information 54 or the information group 70 can be used as a disease example.

Although the first information and the second information on the medical care information of a patient which are associated as the set information 54 are information designated in the time-series data TS which is acquired in advance and displayed on the data display screen 15 in this example, for example, newly input medical care information may be association targets of the set information 54, as the first information and second information in the data display screen 15 or the like. Therefore, in this example, the request reception unit 71 is a reception unit that receives the association instruction for the first information and the second information designated or input with respect to medical care information of the patient.

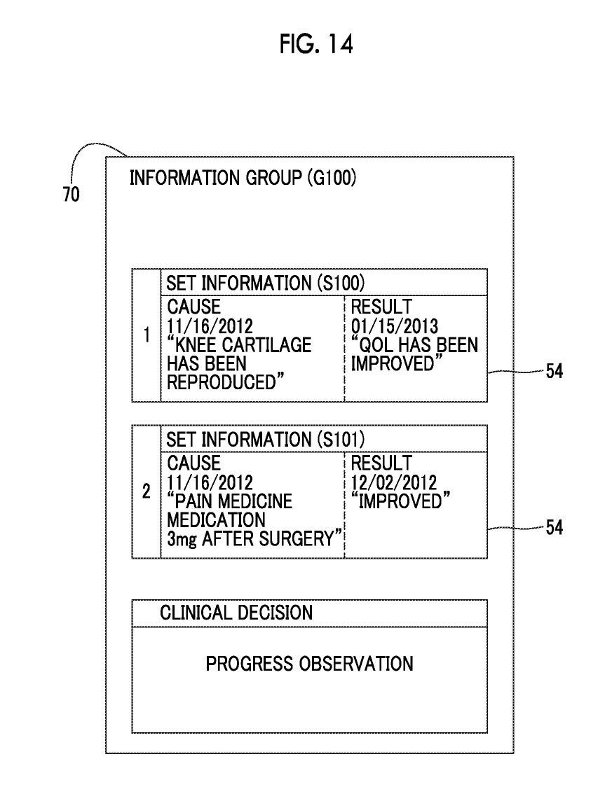

Further, although the example in which the first information and the second information are numerical values such as inspection values or measured values, or images has been described, for example, the first information and the second information may be text data such as medical interview and findings, as illustrated in FIG. 14. The information group 70 having a group ID of “G100” in this example includes two pieces of set information 54. In the first set information 54, a treatment record “the knee cartilage has been reproduced” as a cause and findings of the doctor that “Quality Of Life (QOL)” has been improved as a result have been input. Further, in the second set information 54, a treatment record “pain medicine medication after surgery” as a cause, and findings of the doctor “improvement” as a result have been input. As the clinical decision, “progress observation” is input. It is possible to provide the set information based on such text, that is, useful information as a disease example “pain medicine after surgery has been well worked in an example in which a knee cartilage is reproduced.” Further, in the set information 54 of this example, since the cause and the result are text inputs, there is no input of a comment other than the cause and the result. Thus, there may be no comment in the set information 54.

Further, the information that is input as text is not limited to a medical interview record or a finding of a doctor, and may be an inspection result or a measurement result. For example, in the event that the measured value of the blood pressure decreases from 140 mmHg to 110 mmHg, information input as a result with respect to the set information 54 may be qualitative information “a measured value of the blood pressure is under a normal range”, rather than quantitative information such as a measured value “110 mmHg”.

Further, while one piece of set information 54 including a set of two pieces of information including the first information and the second information has been created in this example, one of piece of set information 54 including a set of three or more pieces of information may be created. For example, one result may be caused by two causes. In such a case, one piece of set information 54 including a set of three or more pieces of information including the first information and the second information indicating the two causes and the third information indicating the result is created. On the other hand, two results may be caused by one cause. In such a case, one piece of set information 54 including a set of three or more pieces of information including first information indicating the cause and second and third information indicating the results is created. In short, assuming that a correspondence relationship between the cause and the result is one-to-many or many-to-one, any number of set targets may be used.

Further, the information group 70 is created in units of clinical decision. For example, in the case of hospital visit, the information group 70 is created in units of issuing of a prescription as a final treatment in one or a plurality of visits. Further, for example, in a case in which an X-ray inspection is performed to capture an X-ray image at a first visit and a drug is prescribed at a second visit, assuming that a causal relationship is ascertained in both of the X-ray inspection and the prescription of the drug, one piece of set information 54 is created, and assuming that any causal relationship in each of the X-ray inspection and the prescription of the drug is ascertained, a plurality of pieces of set information 54 are created. Assuming that a final treatment is determined as a clinical decision, the information group 70 is created. Further, in the case of hospitalization, for example, a plurality of pieces of set information 54 created between hospitalization and hospital discharge is grouped as one information group 70. A variety of methods are considered as a grouping method and, in short, the information group 70 may be a set of causal relationships which serve as a basis of the clinical decision of the doctor (a determination of a medical care plan, such as next treatment or therapy).

Further, although the example in which the information group 70 includes the content of clinical decision has been described in this embodiment, there may be the content of the clinical decision. This is because, assuming that there is the set information 54, content of the clinical decision can be predicted, for example, by viewing an electronic medical chart of the patient from date or the like. Therefore, assuming that there is set information 54 indicating a causal relationship to which the doctor pays attention as a basis for clinical decision among a large number of pieces of medical care information, it is possible to recognize the decision process of the doctor. It should be understood that it is preferable for the content of clinical decision to be included since the confirmation is also easy.

### Second Embodiment

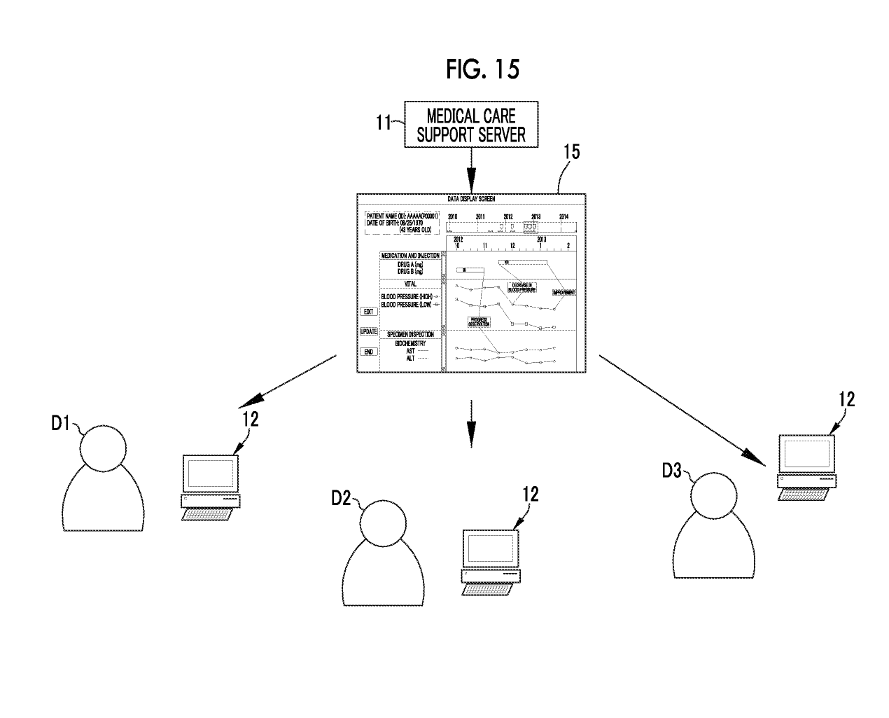

A second embodiment illustrated in FIGS. 15 to 18 is an embodiment in which a conference support function is included so as to use the medical care support server 11 in a conference. Other points are the same as those of the first embodiment, and a difference will be described hereinafter. As illustrated in FIG. 15, the conference is a conference in which a plurality of doctors examine a medical care plan for one patient. In the conference, for example, a plurality of doctors D1 to D3 access the medical care support server 11 using respective client terminals 12 and view the same data display screen 15 at the same time. Medical care information such as time-series data TS for a certain patient is shared among the respective doctors D1 to D3, communication is collected, the medical care plan is examined, and one final clinical decision is made by agreement of the doctors D1 to D3.

The conference is a use form of a computer system and is close to a so-called WEB conference. In the medical care support server 11, the output control unit 78 can distribute the screen data 15A of the same data display screen 15 to a plurality of client terminals 12. In a case in which the data display screen 15 is updated according to a screen edit request from each client terminal 12, the update data is transmitted to other client terminals 12 and the data display screen 15 is synchronized among the respective client terminals 12. An authority of screen editing is limited to, for example, one client terminal 12 which is a conference organizer.

In the conference, a plurality of causal relationships regarding a plurality of pieces of medical care information are discussed by the respective doctors D1 to D3, and logical verification is collected, an appropriate medical care plan is examined for a patient, and a final clinical decision is made. A process of such a discussion corresponds to a flow of a logic leading to an appropriate medical care plan. Accordingly, assuming that this can be simply stored, it is very convenient in the event that the process of discussion is looked back later. Since the set information 54 indicates the causal relationship of a plurality of pieces of medical care information, a plurality of pieces of set information 54 which is a target of the discussion in the conference has a value corresponding to a gist of the flow of discussion. By using the grouping function of the medical care support server 11, it is possible to simply perform work of summarizing a plurality of pieces of set information 54 which are targets of the discussion.

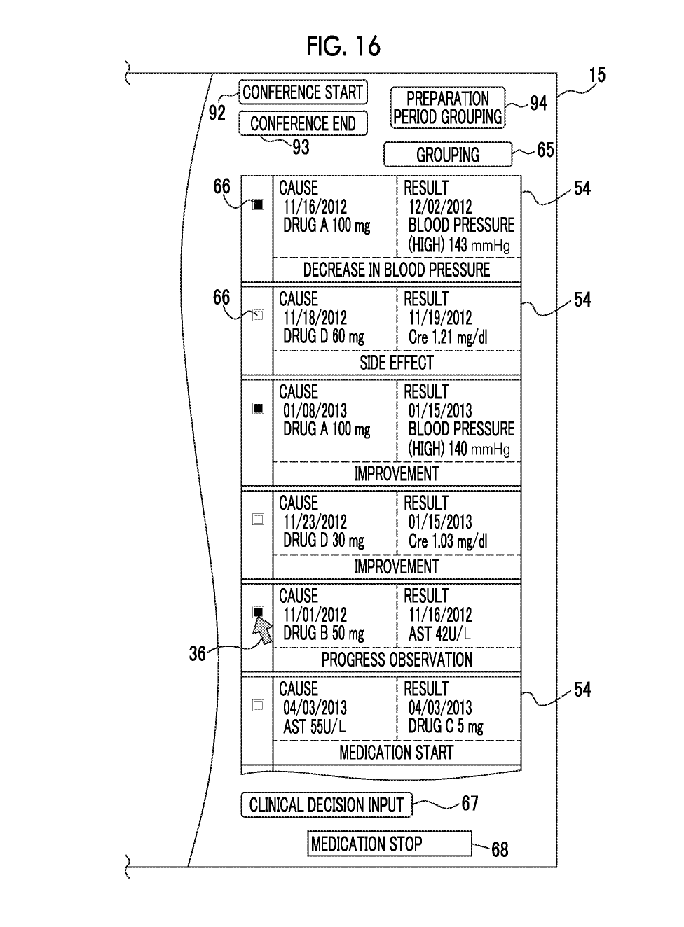

As illustrated in FIG. 16, for example, a conference start button 92, a conference end button 93, a preparation period grouping button (hereinafter referred to as a preparation period button) 94, a clinical decision input button 67, and an input box 68 are provided as the conference support function in the data display screen 15 of the medical care support server 11, in addition to the grouping button 65. The conference start button 92 and the conference end button 93 are operation portions for inputting conference start and end timing. The medical care support server 11 groups a plurality of pieces of set information 54 selected by a check operation of the check box 66 between an operation of the conference start button 92 and an operation of the conference end button 93.

For example, assuming that the conference start button 92 is operated after the grouping button 65 is operated, a grouping instruction is transmitted to the medical care support server 11. The association processing unit 73 determines that the conference starts on the basis of the grouping instruction. A conference ID is also input from an input box (not illustrated) at the time of the operation of the conference start button 92. In this state, assuming that the set information 54 is selected by the check box 66, selection information is transmitted to the medical care support server 11. Assuming that the conference end button 93 is operated, a grouping end instruction is transmitted. The association processing unit 73 determines that the conference has ended, on the basis of the grouping end instruction. Assuming that the association processing unit 73 receives the grouping end instruction, the association processing unit 73 creates the set information 54 selected between the grouping instruction and the grouping end instruction as one information group 70.

Further, set information 54 can be newly created while the grouping is being performed, and the newly created set information 54 can be the grouping target. Further, access information such as creation date and time of the set information 54 or viewing date and time at which the set information 54 is selected by the click operation and viewed is also transmitted to the medical care support server 11 and input to the information group 70, as in the first embodiment.

Further, as in this example, the conference period may include a preparation period in which preparation for a production period is performed, in addition to the production period in which the conference is actually performed. In this example, a period between the operation of the conference start button 92 and the operation of the conference end button 93 is the production period.

The preparation period button 94 is an operation button for grouping the selected set information 54 in a preparation period before the production period of the conference starts. The preparation period button 94 is activated with one click operation. Assuming that the preparation period button 94 is activated, a grouping instruction is transmitted to the medical care support server 11. In the event that the preparation period button 94 is clicked again, the preparation period button 94 is deactivated. Assuming that the preparation period button 94 is deactivated, the grouping end instruction is transmitted. The selected set information 54 is grouped while the preparation period button 94 is being activated. Similar to the grouping during the production period of the conference, the set information 54 before the preparation period button 94 is activated, as well as newly created set information 54 after the preparation period button 94 is activated, can be a group target. For a display order of the information groups 70, the information groups 70 are sorted on the basis of access information or the display order can be arbitrarily set by a doctor who performs prepare work.

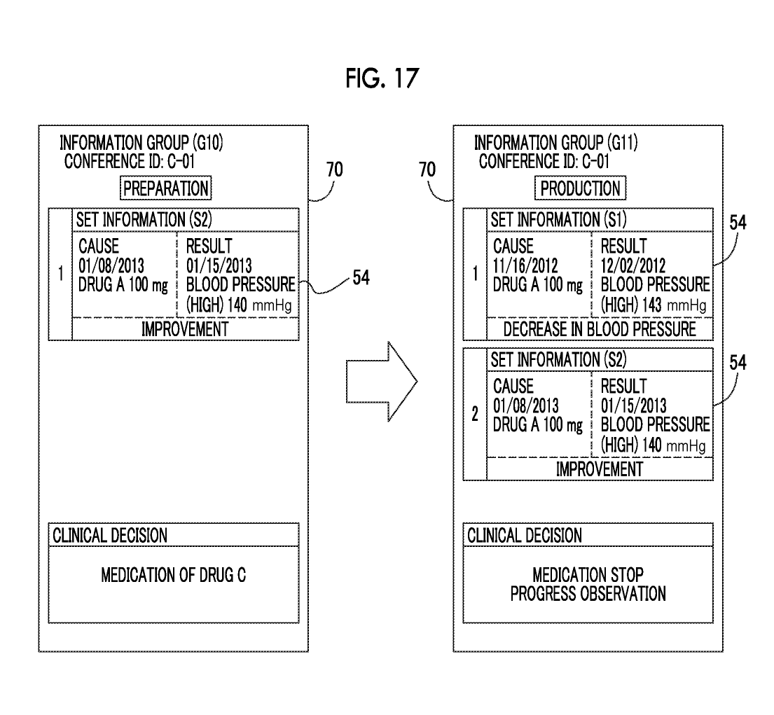

As illustrated in FIG. 17, the conference ID is assigned to the information group 70 in units of conferences. Further, a period type for identifying the production period or the preparation period of the conference is also input. Different group IDs (G10 and G11) are assigned so that the production period and the preparation period are separately recorded. However, since both are related to the same conference, the same conference ID (C-01) is assigned to the information group 70 of each of the preparation period and the production period. Such a process is executed by the association processing unit 73.

A general workflow of the conference is often performed in a procedure in which an organizer examines the medical care plan of the patient, and other doctors are requested to provide an opinion for a result of the examination. Therefore, it is efficient for the organizer to create the information group 70 before the production period in advance and for a discussion of the production period to be progressed on the basis of the created information group 70. By separately storing the information group 70 in the preparation period and the production period of the conference, it is possible to efficiently progress the conference.

In this example, for example, in the information group 70 of the preparation period, the clinical decision “C drug medication” of the organizer is made on the basis of the set information 54 of “S2”. On the other hand, in the information group 70 of the production period, clinical decision of “medication stop” is made by the agreement by paying attention to the set information 54 of “S1” in addition to the set information 54 of “S2”. Thus, by separately storing the information groups 70 of the preparation period and the production period, it can be seen how the set information 54 or the clinical decision has been modified in the production period. Accordingly, it is also possible to recognize a part serving as a focus of discussion in the production period.

If, for a display order of such information groups 70, the information groups 70 are sorted according to viewing date and time or creation date and time and stored, it is easy to recognize the decision process.

Since the conference is performed by a plurality of doctors, reliability of a result of the examination is high, and a value as know-how of the diagnosis is high. Therefore, a discussion process or a finally made clinical decision is further useful as diagnosis support information as compared with a decision process of one doctor. By providing the function corresponding to the conference as in this embodiment, it is possible to simply accumulate such useful information.

Although the conference start button 92 and the conference end button 93 are provided in order to input the start and end timings of the conference in this example, the input of the start and end timings of the conference may be performed, for example, on the basis of schedule information in which a holding period of pre-conference has been recorded. In this case, the medical care support server 11 or the client terminal 12 determines the start time or the end time of the conference by referring to the schedule information. On the basis of a result of this determination, the start and end timings of the conference are input.

### Third Embodiment

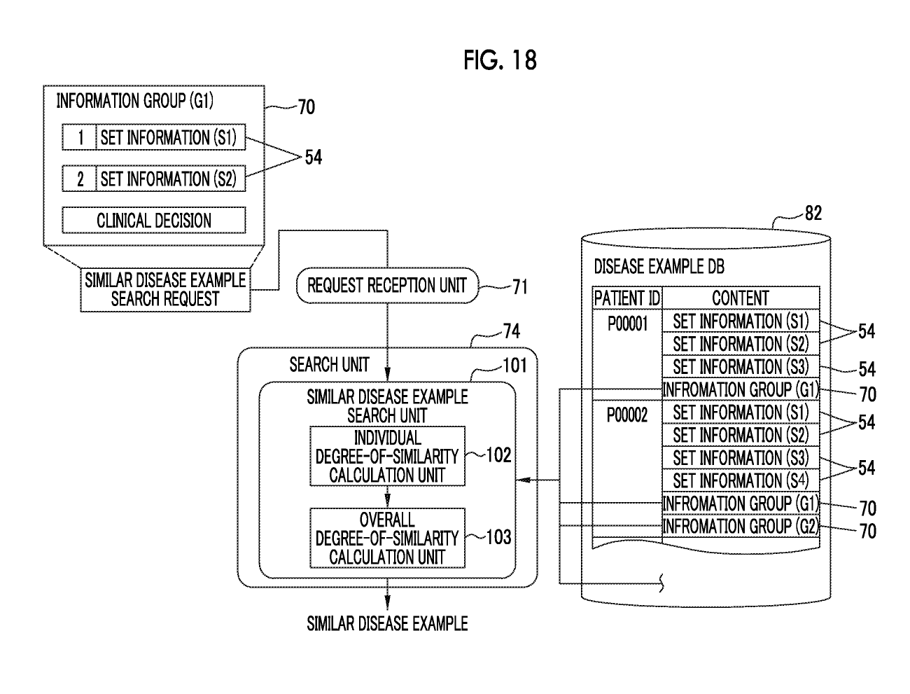

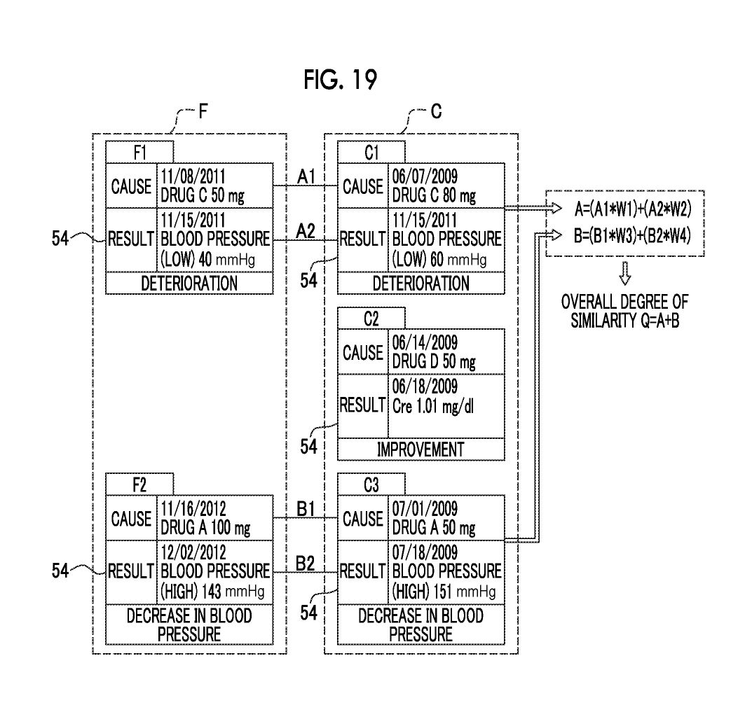

In a third embodiment illustrated in FIGS. 18 and 19, the medical care support server 11 includes a similar disease example search function of searching for a similar disease example that is similar to the set information 54 designated as a search condition from the disease example DB 82 on the basis of a search request in which at least one of set information 54 is designated as a search condition. In the disease example DB 82, a plurality of information groups 70 have been registered. Since the information group 70 includes the clinical decision and the causal relationship serving as the basis of the clinical decision as described above, the information group 70 is available as a disease example.

The request reception unit 71 of the medical care support server 11 is a search request reception unit and receives the search request including the set information 54. In this example, the information group 70 including two pieces of set information 54 is designated as the search condition. Further, a similar disease example search unit 101 is provided in the search unit 74. The similar disease example search unit 101 calculate a degree of similarity between the set information 54 designated as the search condition and a plurality of information groups 70 in the disease example DB 82 (hereinafter referred to as diseases examples), and extracts similar disease examples having a high degree of similarity on the basis of the calculated degree of similarity.

An individual degree-of-similarity calculation unit 102 and an overall degree-of-similarity calculation unit 103 are provided in the similar disease example search unit 101. The individual degree-of-similarity calculation unit 102 compares the set information 54 included in the search condition with the set information 54 included in the disease example in association with each other on a one-to-one basis, and calculates the individual degree of similarity between the pieces of set information 54. In the comparison of the pieces of set information 54, the same types of causes and results are compared (the causes are compared and the results are compared), and the individual degree of similarity is calculated.

As illustrated in FIG. 19, for example, in a case in which there are a plurality of pieces of set information 54 in a search condition F or disease example C, the individual degree-of-similarity calculation unit 102 extracts the set information 54 of the same medical care item as the medical care item of the set information 54 included in the search condition F from the disease example C, compares the set information 54 of the same medical care item with each other on a one-to-one basis, and calculates the individual degree of similarity. The medical care item includes, for example, a measured value of the blood pressure or a dosage of the same drug. It should be understood that a comparison between different medical care items has no meaning. Further, for the medical care item, it is necessary for both of the cause and the result in the set information 54 to be the same.

In this example, set information 54 of “F1” including the dosage of drug C as a cause and the measured value of blood pressure (low) as a result is compared with set information 54 of “C1”, and individual degrees of similarity A1 and A2 are calculated for the cause and the result, respectively. The individual degree-of-similarity calculation unit 102 calculates, for example, an absolute value of a difference between numerical values of the search condition F and the disease example C in a case in which comparison targets are the numerical values. For example, the individual degree of similarity A1 is an absolute value of a difference between the dosages of drug C of the search condition F and the disease example C. Similarly, the individual degree of similarity A2 is an absolute value of a difference between the measured values of blood pressure (low).

The individual degrees of similarity A1 and A2 are individual degrees of similarity of the cause and the result, respectively, and the medical care items are different such as the dosage and the measured value of the blood pressure. Accordingly, a weighting process according to the medical care item is performed. The individual degree-of-similarity calculation unit 102 applies respective weighting coefficients W1 and W2 to the individual degrees of similarity A1 and A2 to calculate normalized values. By performing weighting according to the type of set information 54, such as the medical care items, it is possible to compare the individual degrees of similarity of different types. Further, a sum of the respective normalized individual degrees of similarity A1 and A2 is calculated as an individual degree of similarity A of all of pieces of set information 54.

Further, the set information 54 of “F2” and the set information 54 of “C3” in which the dosage of drug A is included in the cause and the measured value of the blood pressure (high) is included in the result are included in the search condition F and the disease example C, and since the medical care items are the same, the individual degree of similarity is calculated. Similar to the set information 54 of “F1” and “C1”, individual degrees of similarity B1 and B2 of the cause and the result are calculated, and a weighting process is performed. A weighting coefficient W3 according to the dosage of drug C is applied to the individual degree of similarity B1, and a weighting factor W4 according to a measured value of blood pressure (low) is applied to the individual degree of similarity B2. A sum of the individual degrees of similarity B1 and B2 is calculated as an individual degree of similarity B of all of items of set information 54.

The overall degree-of-similarity calculation unit 103 calculates a sum of the plurality of calculated individual degrees of similarity A and B as an overall degree of similarity Q. Such an overall degree of similarity Q is obtained for each disease example. The similar disease example search unit 101 extracts, as a similar disease example, the disease example having a high overall degree of similarity Q from the disease examples of which the overall degrees of similarity Q have been calculated. The similar disease example search unit 101 extracts, for example, about ten disease examples at a higher level as similar disease examples, creates a similar disease example list in which the extracted similar disease examples are arranged in an order of the overall degree of similarity Q, and outputs the similar disease example list as a search result.

The similar disease example list is transmitted to the client terminal 12 that is a request source through the output control unit 78. The client terminal 12 displays the similar disease example list, for example, in a sub-window open on the data display screen 15. Since the doctor can confirm the clinical decision made in a past disease example by referring to the similar disease example list, this may be used as a reference in the clinical decision.

Although the example in which there are the same number (two) of the set information 54 of the same medical care item in the search condition F and the disease example C has been shown in this example, it should be understood that the number of the set information 54 of the same medical care item in the search condition F and the disease example C may not match. In a case in which there are a plurality of pieces of set information 54 of the same medical care item as the set information 54 of the search condition F in the disease example C, one piece of set information 54 of the search condition F and each of the plurality of pieces of set information 54 in the disease example C are associated with each other on a one-to-one basis, and a plurality of individual degrees of similarity are calculated. An overall degree of similarity Q is calculated for each combination of the plurality of individual degrees of similarity of the same medical care item and the individual degree of similarity regarding another medical care item. In this case, a plurality of overall degrees of similarity Q are calculated in a comparison between one search condition F and one disease example C. In this case, a highest overall degree of similarity among the plurality of overall degree of similarity Q may be determined as a representative value.

Further, even in a case in which there are the same number of pieces of set information 54 of the same medical care item in the search condition F and the disease example C, there may be irrelevant set information 54 in a comparison with the search condition F, such as the set information 54 of “C2” in FIG. 19, in the disease example C. Since the set information 54 indicates the causal relationship serving as the basis of the clinical decision, the presence of the irrelevant set information 54 acts to reduce a value as a similar disease example. Therefore, in a case in which there is the irrelevant set information 54 in comparison with the search condition F, it is preferable to perform correction such as a reduction from the overall degree of similarity Q according to the number of pieces of irrelevant set information 54. Accordingly, it is possible to search for a more appropriate similar disease example.

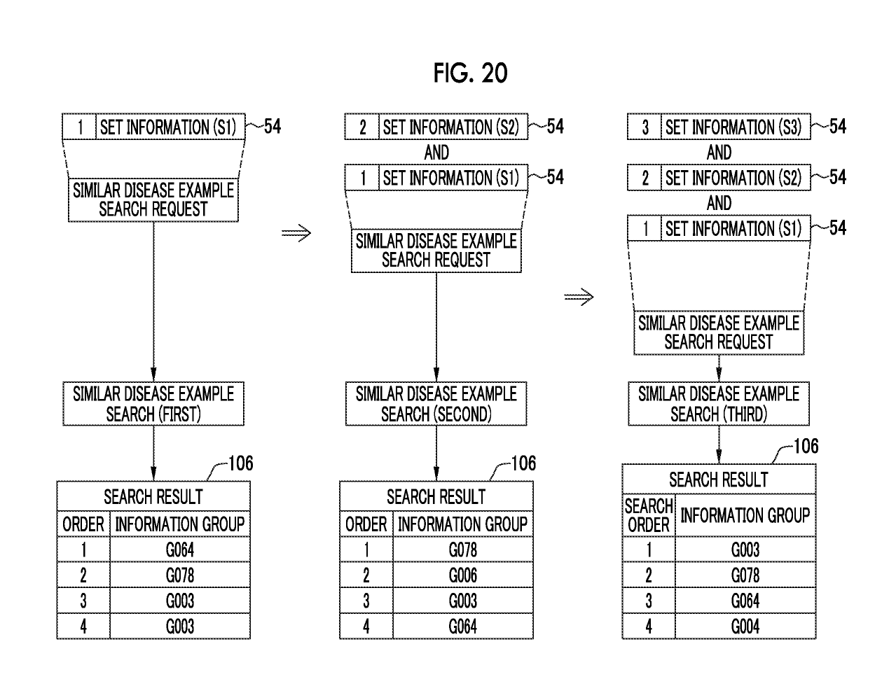

Further, as illustrated in FIG. 20, it is preferable for the similar disease example search unit 101 to perform re-search and output a search result in each re-search each time one piece of set information 54 of the search condition F is added. For example, in a first similar disease example search, one piece of set information 54 is designated as the search condition F. The similar disease example search unit 101 searches for the similar disease example on the basis of one piece of set information 54, and outputs a first search result (similar disease example list 106). Another set information 54 is added and a second similar disease example search is performed. The similar disease example search unit 101 outputs a second search result (similar disease example list 106). Similarly, assuming that another set information 54 is added, a third similar disease example search is performed and a third search result (similar disease example list 106) is output.

The search result is distributed to the client terminal 12 in each search and displayed in, for example, the sub-window of the data display screen 15. Thus, assuming that re-search is performed each time the set information 54 of the search condition F is added and a search result is output in each search, narrowing-down of the similar disease examples can be simply performed. By performing this search each time, the similar disease example can be referred to while a cause and a result are being input on the screen. Accordingly, this helps in the decision of the doctor.

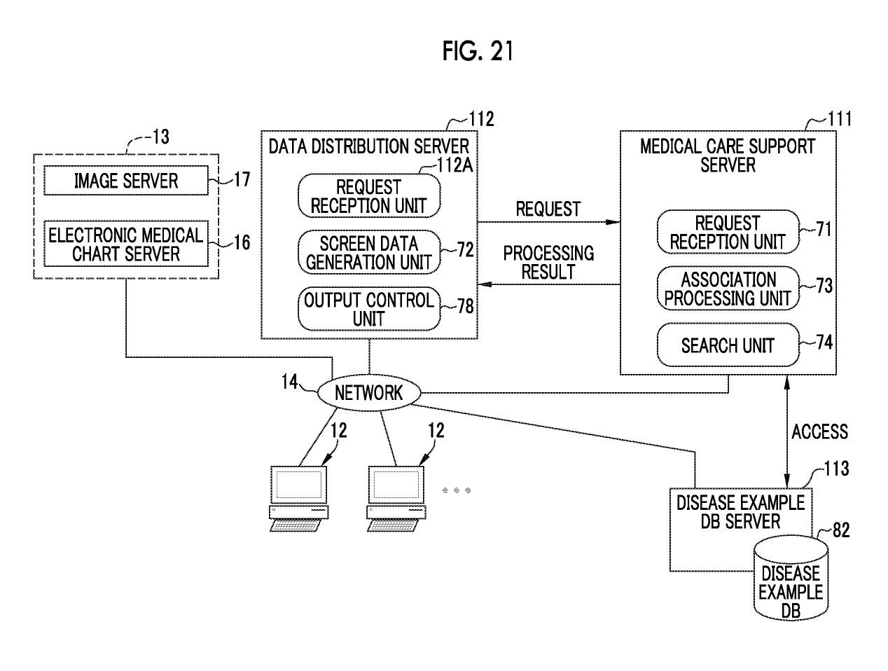

Although the example in which the medical care support device of the present invention is in the form of the medical care support server 11 having a screen distribution function of distributing the screen data of the data display screen for displaying the medical care information on the basis of the request from the client terminal 12 has been described in each embodiment, another server may have the screen distribution function, as in the medical care support server 111 illustrated in FIG. 21.

The medical care support server 111 in FIG. 21 does not have the screen distribution function, and includes only the request reception unit 71, the association processing unit 73, and the search unit 74. In the data distribution server 112, a request reception unit 112A, a screen data generation unit 72, and an output control unit 78 are provided. The association instruction or the grouping instruction, and a request regarding search from the client terminal 12 are transmitted to the medical care support server 111 via the data distribution server 112. The medical care support server 111 distributes a result of a process according to the request to the data distribution server 112. The data distribution server 112 receives the result of the process from the medical care support server 111 and distributes necessary data to the client terminal 12.

Further, the medical care support server 111 is also separated from the disease example DB 82. The disease example DB 82 is provided in the disease example DB server 113. The medical care support server 111 accesses the disease example DB server 113 over the network 14 and performs storage or reading of the set information 54 or the information group 70.

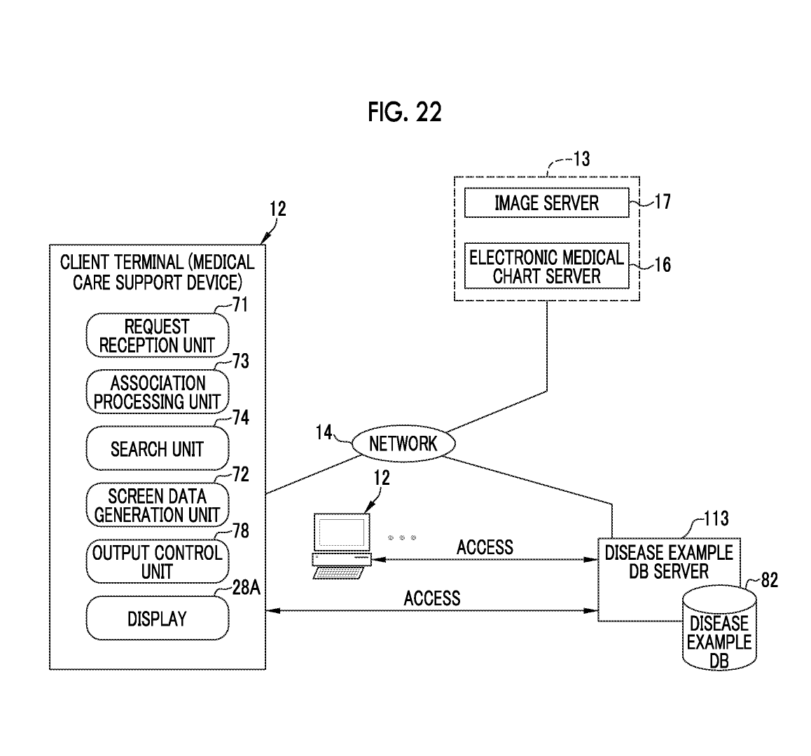

Further, as illustrated in FIG. 22, the client terminal 12 may be used as a medical care support device in place of the medical care support servers 11 and 111. In this case, the request reception unit 71, the screen data generation unit 72, the association processing unit 73, the search unit 74, and the output control unit 78 are provided in the client terminal 12. The client terminal 12 accesses the server group 13 to acquire the time-series data and generates screen data of the data display screen. The client terminal 12 outputs the generated screen data to the display 28A and displays the generated screen data on the display 28A. The client terminal 12 receives an association instruction or a grouping instruction through data display screen, executes a process according to the instruction, and displays a result of the process on the display 28A. Further, the client terminal 12 accesses the disease example DB server 113 to store or read the set information 54 or the information group 70.

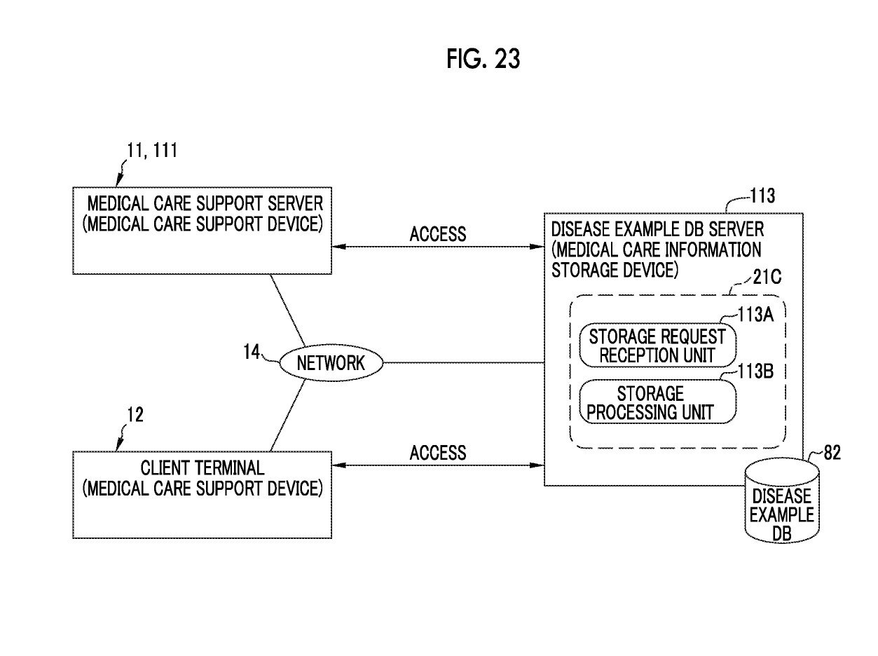

As illustrated in FIG. 23, the disease example DB server 113 is a medical care information storage device in which, by executing a medical care information storage program as an AP 30, a CPU 21C functions as a storage request reception unit 113A and a storage processing unit 113B. The disease example DB server 113 receives access from the medical care support servers 11 and 111 functioning as a medical care support device, and the client terminal 12. The storage request reception unit 113A receives a storage request. The storage processing unit 113B executes a storage process of storing the set information 54 or the information group 70 in the disease example DB 82 on the basis of the storage request. Here, the disease example DB 82 functions as a storage unit.

Thus, the medical care support device or the medical care information storage device of the present invention can be realized in various aspects. Further, a hardware configuration of a computer system, such as the medical care support servers 11 and 111, the client terminal 12, and the disease example DB server 113, can be variously modified. For example, the medical care support servers 11 and 111 and the disease example DB server 113 can include a plurality of server computers separated as hardware in order to improve processing capability or reliability. Thus, the hardware configuration of the computer system can be appropriately changed according to required performance, such as processing capability, safety, and reliability. Further, it should be understood that a program such as the disease example DB 82 or the AP 30, as well as the hardware, can be made redundant or can be distributed and stored in a plurality of storage devices in order to ensure safety or reliability.

Further, although the medical care support servers 11 and 111, and the disease example DB server 113 have been described in a form that the medical care support servers 11 and 111, and the disease example DB server 113 are used within one medical facility in each embodiment, the medical care support servers 11 and 111, and the disease example DB server 113 may be in a form in which the medical care support servers 11 and 111, and the disease example DB server 113 are available to a plurality of medical facilities.

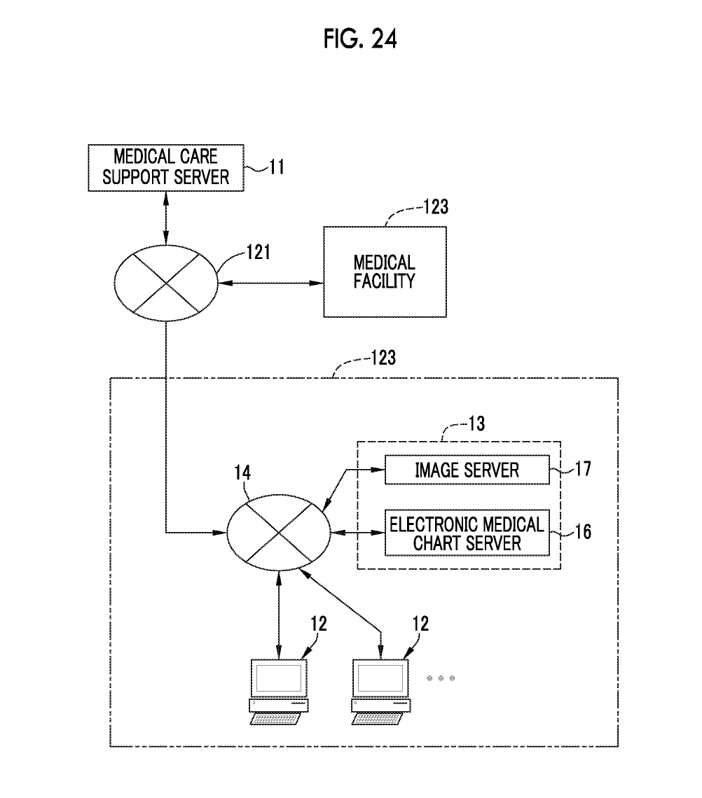

The medical care support server 11 will be described by way of example. In each embodiment, the medical care support server 11 is in the form in which the client terminal 12 installed in one medical facility is connected to the medical care support server 11 to be able to communicate over the network 14 such as a LAN, and the medical care support server 11 provides an application service such as association process or a grouping process on the basis of the request from the client terminal 12. In order for the medical care support server 11 to be available to a plurality of medical facilities, for example, the medical care support server 11 is connected to be able to communicate with the client terminals 12 installed in the plurality of medical facilities 123, for example, over a Wide Area Network (WAN) 121 such as the Internet or a public communication network, as illustrated in FIG. 24. The medical care support server 11 receives the requests from the client terminals 12 in the plurality of medical facilities, and provides the application service such as association processor a grouping process to each client terminal.

An installation place or an operating subject of the medical care support server 11 in this case, for example, may be a data center different form the medical facility 123 or may be one of the plurality of medical facilities 123. Further, in a case in which a WAN is used, it is preferable that a Virtual Private Network (VPN) is constructed or a communication protocol having a high security level such as Hypertext Transfer Protocol Secure (HTTPS) is used in consideration of information security.

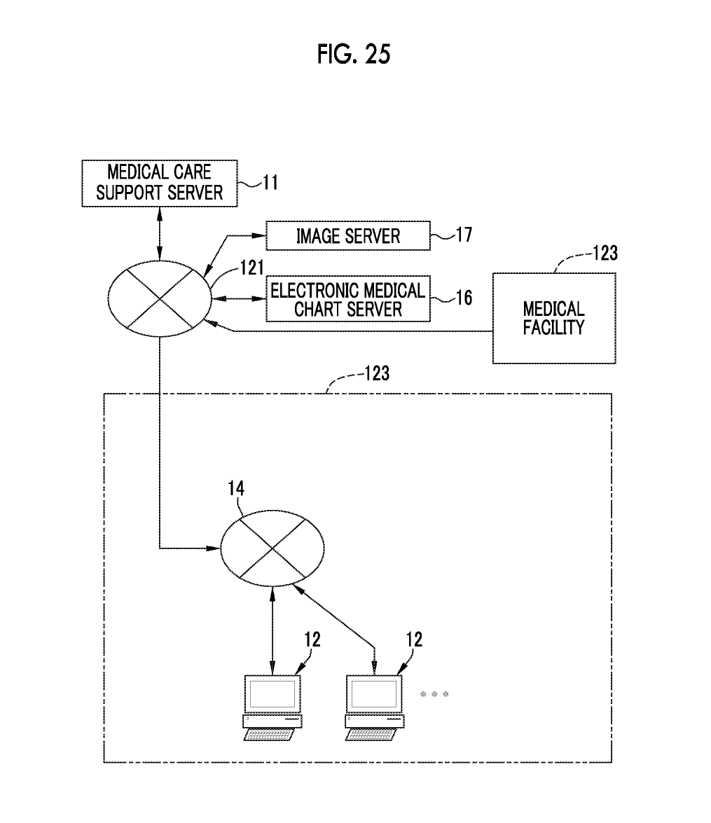

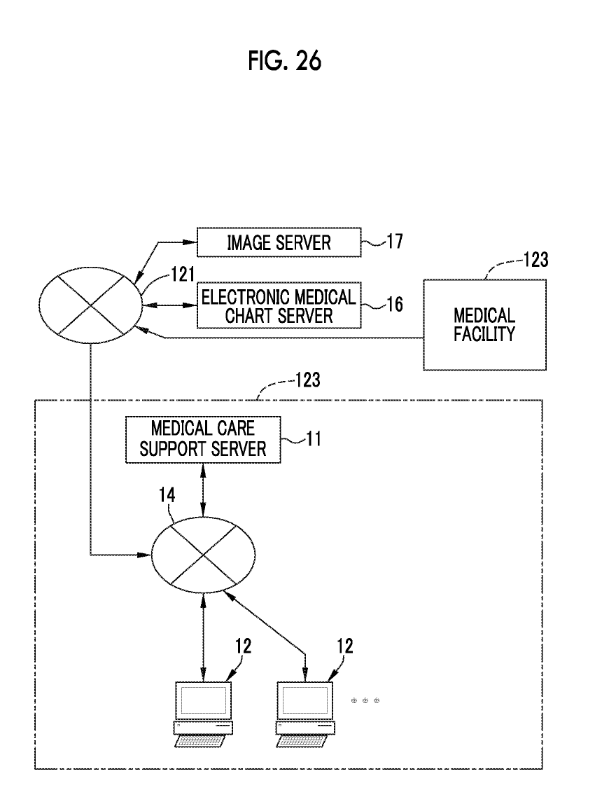

Further, as illustrated in FIG. 25, the electronic medical chart server 16 or the image server 17 may be installed outside the medical facility 123. As illustrated in FIG. 26, the medical care support server 11 may be installed within the medical facility 123 and only the electronic medical chart server 16 or the image server 17 installed in the outside may be used.

It should be understood that the present invention is not limited to each embodiment and various configurations may be adopted as long as the configurations do not depart from the gist of the present invention. For example, various embodiments or various modification examples described above may be appropriately combined. Further, the present invention includes a storage medium that stores the program, in addition to the program.

### EXPLANATION OF REFERENCES

11, 111 medical care support server
12 client terminal
15 data display screen
56 association indicator
54 set information
70 Information group
73 association processing unit
82 disease example database
101 degree-of-similarity disease example search unit
G graph
TS time-series data

What is claimed is:

1. A medical care support device, comprising:
a reception unit that receives an association instruction for first information and second information that are designated or input with respect to medical care information of a patient; and
an association processing unit that creates one piece of set information including at least two pieces of information including the first information and the second information on the basis of the association instruction, and groups the one or more pieces of set information in units of clinical decision to create an information group.

2. The medical care support device according to claim 1,
wherein the association processing unit is capable of adding an input comment to the set information, in addition to the first and second information.

3. The medical care support device according to claim 1,
wherein the set information includes causal relationship information indicating that one of the first information and the second information corresponds to a cause and the other corresponds to a result.

4. The medical care support device according to claim 1,
wherein the association processing unit is capable of adding content of the clinical decision to the information group, in addition to the set information.

5. The medical care support device according to claim 1,
wherein the medical care information includes first time-series data and second time-series data which are data series over time regarding a state transition and medical care of the patient,
the first information is data of a first designated position in the first time-series data, and
the second information is data of a second designated position in second time-series data.

6. The medical care support device according to claim 1, further comprising:
a search request reception unit that receives a search request in which at least one piece of set information is designated as a search condition; and
a similar disease example search unit that searches for a similar disease example that is similar to the set information designated as the search condition from the disease example database in which a plurality of information groups are registered as disease examples.

7. The medical care support device according to claim 6,
wherein the similar disease example search unit includes
an individual degree-of-similarity calculation unit that compares a plurality of pieces of set information included in the search condition with a plurality of pieces of set information included in the disease example on a one-to-one basis, and calculates an individual degree of similarity between pieces of set information, and
an overall degree of similarity calculation unit that calculates an overall degree of similarity between the information group of the plurality of pieces of set information included in the search condition and the disease example on the basis of the plurality of calculated individual degrees of similarity, and
wherein the similar disease example is searched for on the basis of the overall degree of similarity, and a result of the search is output.

8. The medical care support device according to claim 7,
wherein one of the first information and the second information included in the set information corresponds to a cause, and the other corresponds to a result, and
the individual degree-of-similarity calculation unit calculates the individual degree of similarity through a comparison between the same types corresponding to the causes and the results for the first information and the second information.

9. The medical care support device according to claim 7,
wherein the similar disease example search unit performs a weighting process on the individual degree of similarity according to the type of set information.

10. The medical care support device according to claim 7,
wherein the similar disease example search unit performs re-search each time one piece of set information of the search condition is added, and outputs the search result in each re-search.

11. The medical care support device according to claim 1, further comprising:
a screen data generation unit that generates screen data of a display screen for displaying the medical care information, the display screen being capable of allowing an input of the association instruction for the first information and the second information and a display of the set information.

12. The medical care support device according to claim 11,
wherein in a case in which the screen data of the display screen is distributed to a plurality of terminals and used in a conference in which a plurality of people examine a medical care plan for a patient,
the association processing unit is capable of storing the plurality of pieces of set information accessed during a period of the conference, in the information group having one conference as a unit.

13. The medical care support device according to claim 12,
wherein there are a preparation period and a production period in the period of the conference, and
the association processing unit is capable of separately storing an information group created in the production period and an information group created in the preparation period.

14. The medical care support device according to claim 11,
wherein an operation portion for inputting start and end timings of the conference is provided in the display screen, and
the association processing unit determines start and end of the conference according to an input from the operation portion.

15. The medical care support device according to claim 11,
wherein the association processing unit stores an access order for a plurality of pieces of set information accessed during a period of the conference, as access information.

16. A medical care support method, comprising:
a reception step of receiving an association instruction for first information and second information that are designated or input with respect to medical care information through a display screen for displaying the medical care information of a patient; and
an association processing step of creating one piece of set information including a set of at least two pieces of information including the first information and the second information on the basis of the association instruction, and grouping one or more pieces of set information in units of clinical decision to create an information group.

17. A medical care information storage device, comprising:
a storage request reception unit that receives a storage request to store one piece of set information including a set of at least first information and second information associated with respect to medical care information of a patient, and an information group including one or more pieces of set information and grouped in units of clinical decision; and
a storage processing unit that stores the set information and the information group in a storage unit on the basis of the received storage request.

18. A medical care information storage method, comprising:
a storage request reception step of receiving a storage request to store one piece of set information including a set of at least first information and second information associated with respect to medical care information of a patient, and an information group including one or more pieces of set information and grouped in units of clinical decision; and
a storage processing step of storing the set information and the information group in a storage unit on the basis of the received storage request.
